(19) United States
(12) Patent Application Publication
(10) Pub. No.: US 2015/0161144 A1
(43) Pub. Date: Jun. 11, 2015

(54) DOCUMENT CLASSIFICATION APPARATUS AND DOCUMENT CLASSIFICATION METHOD

(71) Applicants: Kabushiki KaishaToshiba, Minato-ku (JP); Toshiba Solutions Corporation, Kawasaki-shi (JP)

(72) Inventors: Kazuyuki GOTO, Kawasaki (JP); Guowei ZU, Inagi (JP); Yasunari MIYABE, Chofu (JP); Hideki IWASAKI, Fuchu (JP)

(73) Assignees: Kabushiki KaishaToshiba, Minato-ku (JP); Toshiba Solutions Corporation, Kawasaki-shi (JP)

(21) Appl. No.: 14/627,734

(22) Filed: Feb. 20, 2015

Related U.S. Application Data
(63) Continuation of application No. PCT/JP2013/072481, filed on Aug. 22, 2013.

(30) Foreign Application Priority Data
Aug. 22, 2012 (JP) 2012-183534

(51) Int. Cl. G06F 17/30; G06F 17/27

(52) U.S. Cl. CPC G06F 17/3071; G06F 17/275

(57) ABSTRACT

According to one embodiment, there is provided a document classification apparatus including an inter-word corresponding relationship extraction unit configured to extract the corresponding relationship between words in different languages based on a frequency with which the words in the different languages co-occurrently appear between the documents having the corresponding relationship, and an inter-category corresponding relationship extraction unit configured to extract the corresponding relationship between categories into which the documents in the different languages are classified, based on the corresponding relationship between the words.

### CROSS-REFERENCE TO RELATED APPLICATIONS

This application is a Continuation application of PCT Application No. PCT/JP2013/072481, filed Aug. 22, 2013 and based upon and claiming the benefit of priority from Japanese Patent Application No. 2012-183534, filed Aug. 22, 2012, the entire contents of all of which are incorporated herein by reference.

### FIELD

Embodiments described herein relate generally to a document classification apparatus and a document classification method for classifying an enormous number of digitized documents in accordance with their contents.

### BACKGROUND

Along with the growth in computer performance and the capacity of storage media or proliferation of computer networks in recent years, it has become possible to collect, store, and use an enormous number of digitized documents using a computer system. Automatic classification, clustering, and the like of documents are expected as technologies for organizing such an enormous number of documents into a form easy to use.

In particular, activities of corporations and the like have undergone rapid globalization of late. Under the circumstances, it is required to efficiently classify documents described in not only one language but also a plurality of natural languages such as Japanese, English, and Chinese.

There is a need to, for example, classify patent documents applied in a plurality of countries based on not the difference in language but the similarity of contents and analyze trends in applications. There is also a need to, for example, accept, at contact centers in a plurality of countries, information such as questions and complaints from customers concerning a product on sale in the countries and classify/analyze the information. There also exists a need to, for example, collect and analyze information such as news articles and ratings/opinions about a product/service, or the like, which are described in various languages and made open to the public via the Internet.

One method of cross-lingually classifying document sets of different languages based on the similarity of contents uses machine translation technology. In this method, each document described in a language (for example, English or Chinese when Japanese is the native language) other than the native language is translated such that all documents are processable as documents of one language (that is, native language), and after that, automatic classification, clustering, or the like is performed.

However, this method has a problem of accuracy; for example, the accuracy of automatic classification depends on the accuracy of machine translation, and documents cannot appropriately be classified due to a translation error and the like. In addition, since the calculation cost for processing of machine translation is generally high, a problem of performance arises when processing an enormous number of documents.

Furthermore, when a plurality of users classify and use documents, the native languages of the documents are also considered to vary. It is therefore difficult to translate an enormous number of documents into a plurality of languages in advance.

Another method of cross-lingually classifying document sets described in a plurality of languages uses a bilingual dictionary (translation dictionary). Here, the bilingual dictionary is a dictionary or thesaurus that associates an expression such as a word or a phrase described in a given language with a synonymous expression in a different language. For the sake of simplicity, the expression, including a compound word and a phrase, will simply be referred to as a word hereinafter.

As an example of the method of implementing cross-lingual classification using a bilingual dictionary, first, out of a document set described in a plurality of languages, subsets of documents described in language 1 are classified, and categories are created. A word in a language a representing the feature of each category is obtained in a form of, for example, a word vector. On the other hand, for a document in another language b, a word vector in the language b representing the feature of the document is obtained.

Here, when each dimension (that is, word in the language a) of the word vector of each category in the language a and each dimension (that is, word in the language b) of the word vector of a document in the language b can be associated using the bilingual dictionary, the similarity between the word vector in the language a and the word vector in the language b can be calculated. The document in the language b can thus be classified into an appropriate one of the categories in the language a based on the similarity.

In the method using a bilingual dictionary, the quality and quantity of the bilingual dictionary are important. However, labor is necessary to manually create the whole bilingual dictionary. As a method of semiautomatically creating a bilingual dictionary, there is a method of obtaining, in correspondence with a word described in a certain language, a word described in another appropriate language as an equivalent based on a general-purpose bilingual dictionary and the cooccurrence frequency of the word in the corpus (database of model sentences) of each language.

In this method, for example, a technical term or the like whose expression in one language is known but whose expression in the other language corresponding to the above expression is unknown needs to be designated as a word for which a bilingual dictionary is to be created. However, when classifying documents of unknown contents, a word for which a bilingual dictionary should be created cannot be assumed in advance.

Hence, the method using the cooccurrence frequency and the bilingual dictionary is not suitable for the purpose of classifying documents of unknown contents by a heuristic method such as clustering. Additionally, the above-described method needs a general-purpose bilingual dictionary as well as the semiautomatically created bilingual dictionary. However, it may be impossible to sufficiently prepare the general-purpose bilingual dictionary in advance depending on the target language.

Furthermore, Japanese words corresponding to, for example, an English word “character” are “ [symbol] ”, “ [symbol] ”, “ [symbol] ”, “ [symbol] ”, and the like. For this reason, especially when using the general-purpose bilingual dictionary, an appropriate equivalent needs to be selected in accordance with the document set to be classified.

There is also a method of automatically classifying a document using a thesaurus of equivalents created by the above-described method. In this method, if the document is not classified into an appropriate category, the user corrects the meaning of a word in the thesaurus corresponding to a category, thereby coping with a classification error or the like. However, this operation is particularly laborious for a user who is unfamiliar with the target language.

### BRIEF DESCRIPTION OF DRAWINGS

FIG. 1 is a block diagram showing an example of the arrangement of a multilingual document classification apparatus according to the embodiment;

FIG. 2 is a block diagram showing an example of the arrangement of the multilingual document classification apparatus according to the embodiment;

FIG. 3 is a block diagram showing an example of the arrangement of the multilingual document classification apparatus according to the embodiment;

FIG. 4 is a block diagram showing an example of the arrangement of the multilingual document classification apparatus according to the embodiment;

FIG. 5 is a block diagram showing an example of the arrangement of the multilingual document classification apparatus according to the embodiment;

FIG. 6A is a view showing, in a table format, an example of data of documents stored in a document storage unit;

FIG. 6B is a view showing, in a table format, an example of data of documents stored in the document storage unit;

FIG. 6C is a view showing, in a table format, an example of data of documents stored in the document storage unit;

FIG. 7A is a view showing an example of data of categories stored in a category storage unit;

FIG. 7B is a view showing an example of data of categories stored in the category storage unit;

FIG. 7C is a view showing an example of data of categories stored in the category storage unit;

FIG. 7D is a view showing an example of data of categories stored in the category storage unit;

FIG. 8 is a view showing, in a table format, an example of the relationship between documents stored in an inter-document corresponding relationship storage unit;

FIG. 9 is a view showing, in a table format, an example of dictionary words stored in a dictionary storage unit;

FIG. 10 is a flowchart showing an example of the procedure of processing of an word extraction unit;

FIG. 11 is a flowchart showing an example of the procedure of processing of an inter-word corresponding relationship extraction unit;

FIG. 12 is a view showing an example of the relationship between words extracted by an inter-word corresponding relationship extraction unit;

FIG. 13 is a flowchart showing an example of the procedure of processing of the category generation unit;

FIG. 14 is a flowchart showing an example of the procedure of processing of generating word vectors of a plurality of languages of a category;

FIG. 15 is a flowchart showing an example of the procedure of processing of an inter-category corresponding relationship extraction unit;

FIG. 16A is a view showing, in a table format, an example of the relationship between categories extracted by an inter-category corresponding relationship extraction unit;

FIG. 16B is a view showing, in a table format, an example of the relationship between categories extracted by an inter-category corresponding relationship extraction unit;

FIG. 17 is a flowchart showing an example of the procedure of processing of a case-based document classification unit;

FIG. 18 is a flowchart showing an example of the procedure of processing of a category feature word extraction unit;

FIG. 19 is a flowchart showing an example of the procedure of processing of a category feature word conversion unit;

FIG. 20 is a view showing, in a table format, an example of feature words extracted by the category feature word extraction unit and converted by the category feature word conversion unit;

FIG. 21 is a flowchart showing an example of the procedure of processing of a classification rule conversion unit;

FIG. 22A is a view showing, in a table format, an example of a category classification rule converted by a classification rule conversion unit;

FIG. 22B is a view showing, in a table format, an example of a category classification rule converted by a classification rule conversion unit;

FIG. 23 is a flowchart showing an example of the procedure of processing of a dictionary conversion unit 16 shown in FIG. 5;

FIG. 24A is a view showing, in a table format, an example of dictionary words converted by a dictionary conversion unit; and

FIG. 24B is a view showing, in a table format, an example of dictionary words converted by a dictionary conversion unit.

### DETAILED DESCRIPTION

In general, according to one embodiment, there is provided a document classification apparatus including a document storage unit configured to store a plurality of documents in different languages, an inter-document corresponding relationship storage unit configured to store a corresponding relationship between the documents in the different languages which are stored in the document storage unit, and a category storage unit configured to store a category to classify the plurality of documents stored in the document storage unit.

The document classification apparatus includes a word extraction unit configured to extract words from the documents stored in the document storage unit.

The document classification apparatus includes an inter-word corresponding relationship extraction unit configured to extract the corresponding relationship between the words extracted by the word extraction unit, using the corresponding relationship between the documents described in the different languages and stored in the inter-document corresponding relationship storage unit and based on a frequency with which the words extracted by the word extraction unit co-occurrently appear between the documents having the corresponding relationship.

The document classification apparatus includes a category generation unit configured to generate the category for each language by clustering, based on a similarity of the frequency with which the words extracted by the word extraction unit appear between the documents in the same language, which are stored in the document storage unit, the plurality of documents described in the language.

The document classification apparatus includes an inter-category corresponding relationship extraction unit configured to extract the corresponding relationship between the categories into which the documents described in the different languages are classified by regarding assuming that the more inter-word corresponding relationships exist there are between a word that frequently appears in a document classified into a certain category and a word that frequently appears in a document classified into another category, the higher the similarity between the categories is, based on the frequency of the word that appears in the document classified into each category generated for each language by the category generation unit and the corresponding relationship between the words described in different languages, which is extracted by the inter-word corresponding relationship extraction unit.

An embodiment will now be described with reference to the accompanying drawings.

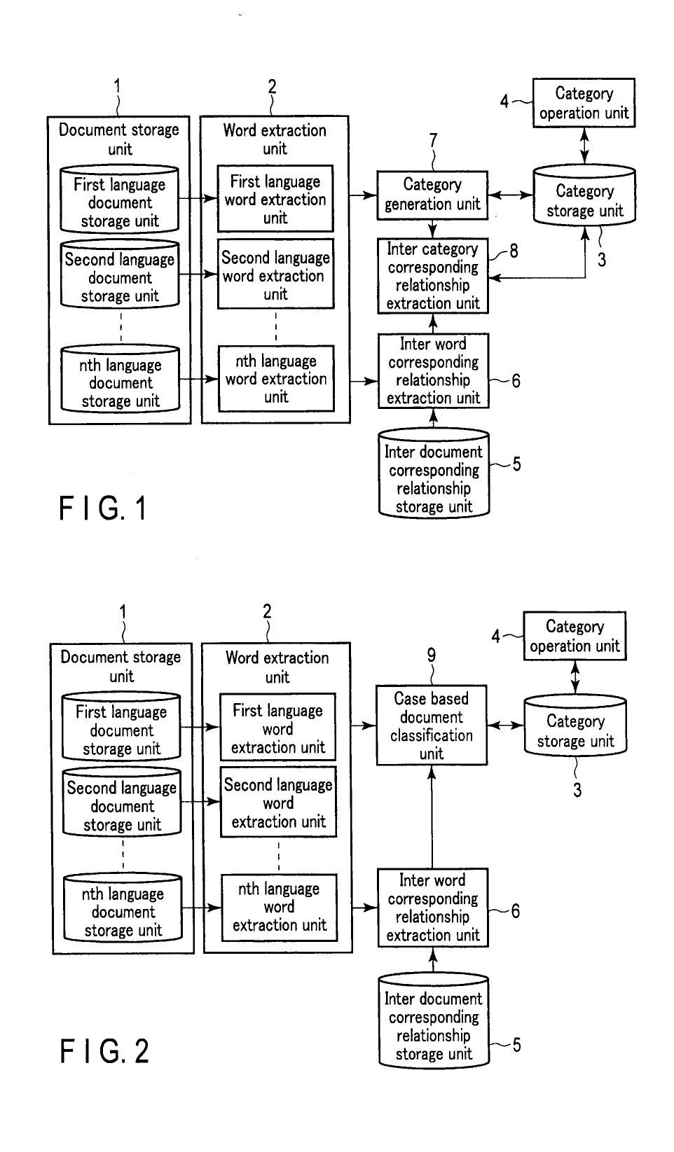

FIGS. 1, 2, 3, 4, and 5 are block diagrams showing examples of the arrangement of a multilingual document classification apparatus according to the embodiment. The arrangements shown in FIGS. 1, 2, 3, 4, and 5 are partially provided with different units in accordance with a function to be implemented. However, a document storage unit 1, a word extraction unit 2, a category storage unit 3, a category operation unit 4, an inter-document corresponding relationship storage unit 5, and an inter-word corresponding relationship extraction unit 6, which are basic units, are common to the arrangements. A description will be made below mainly using FIG. 1 as a representative arrangement.

Referring to FIG. 1, the document storage unit 1 stores data of a plurality of documents to be classified by the document classification apparatus. The document storage unit 1 is implemented by a storage device, for example, a nonvolatile memory. The word extraction unit 2, the category storage unit 3, the inter-document corresponding relationship storage unit 5, and the inter-word corresponding relationship extraction unit 6 are implemented by a processor, for example, a CPU. The document storage unit 1 stores and manages data of documents in different languages. FIG. 1 illustrates the document storage unit 1 in the form of a first language document storage unit, a second language document storage unit, . . . , an nth language document storage unit. More specifically, documents described in languages such as Japanese, English, and Chinese are stored in the document storage units for the languages.

The word extraction unit 2 extracts a word from the data of a document. More specifically, the word extraction unit 2 extracts a word that is data necessary for processing of, for example, classifying a document by morphological analysis or the like, and obtains, for example, the appearance frequency of each word in each document.

To cope with documents in different languages, the word extraction unit 2 is formed from units for the languages, that is, a first word extraction unit, a second word extraction unit, . . . , an nth word extraction unit, as shown in FIG. 1. More specifically, the word extraction unit 2 provides units configured to perform processing such as morphological analysis for languages such as Japanese, English, and Chinese.

The category storage unit 3 stores and manages data of categories to classify documents. The category storage unit 3 is implemented by a storage device, for example, a nonvolatile memory. Generally, in the category storage unit 3, the documents are classified by a plurality of categories having a hierarchical structure in accordance with the contents. The category storage unit 3 stores data of documents classified into each category and data of the parent-child relationship between the categories in the hierarchical structure of the categories.

The category operation unit 4 accepts an operation such as browsing or editing by the user for the data of categories stored in the category storage unit 3.

The category operation unit 4 is generally implemented using a graphical user interface (GUI). By the category operation unit 4, the user can perform an operation for a document.

More specifically, the operation is an operation for a category or an operation of classifying a document into a category or moving a document classified in a category to another category. The operation for a category is category create, delete, move (changing the parent-child relationship in the hierarchical structure), copy, integrate (integrating a plurality of categories into one), or the like.

The inter-document corresponding relationship storage unit 5 stores the corresponding relationship between the documents stored in the document storage unit 1. The inter-document corresponding relationship storage unit 5 is implemented by a storage device, for example, a nonvolatile memory. Generally, the inter-document corresponding relationship storage unit 5 stores and manages data representing the corresponding relationship between documents described in different languages. When classifying patent documents, an example of the specific corresponding relationship between documents is the corresponding relationship between a Japanese patent and a U.S. patent in right of priority or international patent application.

The inter-word corresponding relationship extraction unit 6 automatically extracts the corresponding relationship between words described in different languages based on a word extracted by the word extraction unit 2 from a document described in each language and the corresponding relationship between the documents stored in the inter-document corresponding relationship storage unit 5.

An example of the specific corresponding relationship between the words described in different languages, which is extracted by the inter-word corresponding relationship extraction unit 6, is a corresponding relationship close to equivalents such as the corresponding relationship between a Japanese word “ [symbol] ”, an English word “character”, and a Chinese word “ [symbol] ”.

A category generation unit 7 and an inter-category corresponding relationship extraction unit 8 shown in FIG. 1 implement functions unique to the arrangement of FIG. 1. The category generation unit 7, and inter-category corresponding relationship extraction unit 8 are implemented by the processor.

The category generation unit 7 automatically generates categories by clustering a plurality of documents described in the same language based on the similarity of appearance frequencies of a word extracted from each document by the word extraction unit 2.

The inter-category corresponding relationship extraction unit 8 generally automatically extracts the corresponding relationship between a plurality of categories that are the categories generated by the category generation unit 7 and used to classify document groups of different languages. The categories and the corresponding relationship between the categories generated by these units are stored in the category storage unit 3.

According to the embodiment shown in FIG. 1, for a plurality of documents described in a plurality of different natural languages, a classification structure for classifying the documents described in each language is automatically generated for each language. In addition, the corresponding relationship between categories for classifying the documents described in different languages is automatically extracted. In the embodiment shown in FIG. 1, when the categories whose corresponding relationship is obtained are integrated, the categories for classifying documents of similar contents can easily be created independently of the language.

In an arrangement according to an embodiment shown in FIG. 2, a multilingual document classification apparatus includes a case-based document classification unit 9 configured to implement a function unique to the arrangement shown in FIG. 2 in addition to a document storage unit 1, a word extraction unit 2, a category storage unit 3, a category operation unit 4, an inter-document corresponding relationship storage unit 5, and an inter-word corresponding relationship extraction unit 6 shown in FIG. 1. The case-based document classification unit is implemented by the processor.

The case-based document classification unit 9 performs automatic classification processing. More specifically, for one or a plurality of categories stored in the category storage unit 3, the case-based document classification unit 9 automatically determines, based on one or a plurality of classified documents which are already classified into the categories, whether to classify, into the category, an unclassified document yet to be classified into a category.

Based on words extracted from each document by the word extraction unit 2 and the corresponding relationship between words extracted by the inter-word corresponding relationship extraction unit 6, the case-based document classification unit 9 can determine whether to classify not only an unclassified document described in the same language as the classified documents of a category but also an unclassified document described in another language to the category.

According to the embodiment shown in FIG. 2, based on a document described in a certain language and already classified into a certain category, the multilingual document classification apparatus can automatically classify a document described in another language and having contents similar to those of the above document into the category. It is unnecessary to classify documents described in all languages into categories as supervisor documents, and classifying only documents described in a language easy for the user to understand the contents as supervisor documents suffices. It is therefore possible to easily classify the documents.

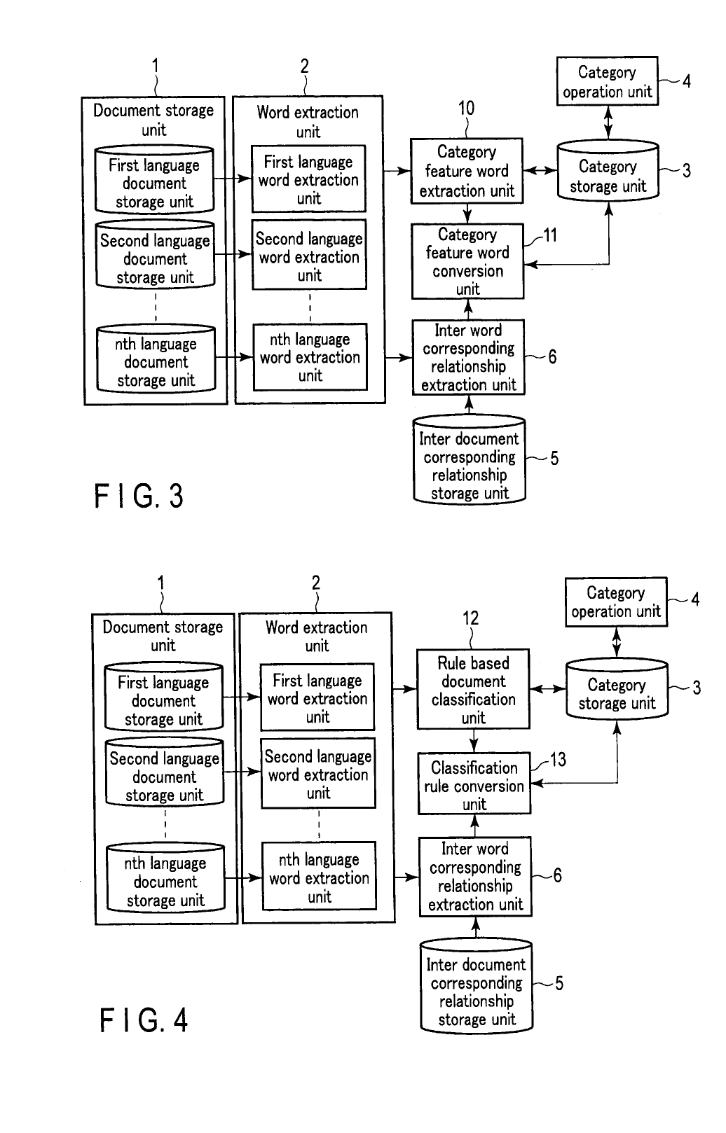

In an arrangement according to an embodiment shown in FIG. 3, a multilingual document classification apparatus includes a category feature word extraction unit 10 and a category feature word conversion unit 11, which are units configured to implement a function unique to the arrangement shown in FIG. 3, in addition to a document storage unit 1, a word extraction unit 2, a category storage unit 3, a category operation unit 4, an inter-document corresponding relationship storage unit 5, and an inter-word corresponding relationship extraction unit 6 shown in FIG. 1. The category feature word extraction unit 10 and the category feature word conversion unit 11 are implemented by the processor.

For one or a plurality of categories stored in the category storage unit 3, the category feature word extraction unit 10 extracts characteristic words representing the contents of documents classified into each category. The characteristic word will be referred to as a feature word hereinafter as needed.

The feature word is a word extracted by selecting an appropriate word representing the feature of a category well from the words extracted by the word extraction unit 2 from the documents classified into the category, as will be described later.

The category feature word conversion unit 11 converts a feature word described in a certain language and extracted from a category into a feature word described in another language based on the corresponding relationship between words described in different languages, which is extracted by the inter-word corresponding relationship extraction unit 6.

According to the embodiment shown in FIG. 3, the multilingual document classification apparatus can automatically extract a feature word of a category, convert the feature word into a language easy for the user to understand, and present it. Hence, the user can easily understand the contents of a document classified into the category.

In an arrangement according to an embodiment shown in FIG. 4, a multilingual document classification apparatus includes a rule-based document classification unit 12 and a classification rule conversion unit 13, which are configured to implement a function unique to the arrangement shown in FIG. 4, in addition to a document storage unit 1, a word extraction unit 2, a category storage unit 3, a category operation unit 4, an inter-document corresponding relationship storage unit 5, and an inter-word corresponding relationship extraction unit 6 shown in FIG. 1. The rule-based document classification unit 12 and the classification rule conversion unit 13 are implemented by the processor.

By a classification rule set for each category stored in the category storage unit 3, the rule-based document classification unit 12 determines a document to be classified into the category. In general, the classification rule of each category is defined to classify, into the category, a document in which one or a plurality of words out of words extracted from documents by the word extraction unit 2 appear.

The classification rule conversion unit 13 converts a classification rule used to classify a document described in a certain language into a classification rule used to classify a document described in another language based on the corresponding relationship between words described in different languages, which is extracted by the inter-word corresponding relationship extraction unit 6.

According to the embodiment shown in FIG. 4, for the classification rules that define documents to be classified into the categories, the multilingual document classification apparatus can automatically convert a classification rule used to classify a document described in a certain language into a classification rule used to classify a document described in another language. This reduces the operation of causing the user to create and maintain the classification rules.

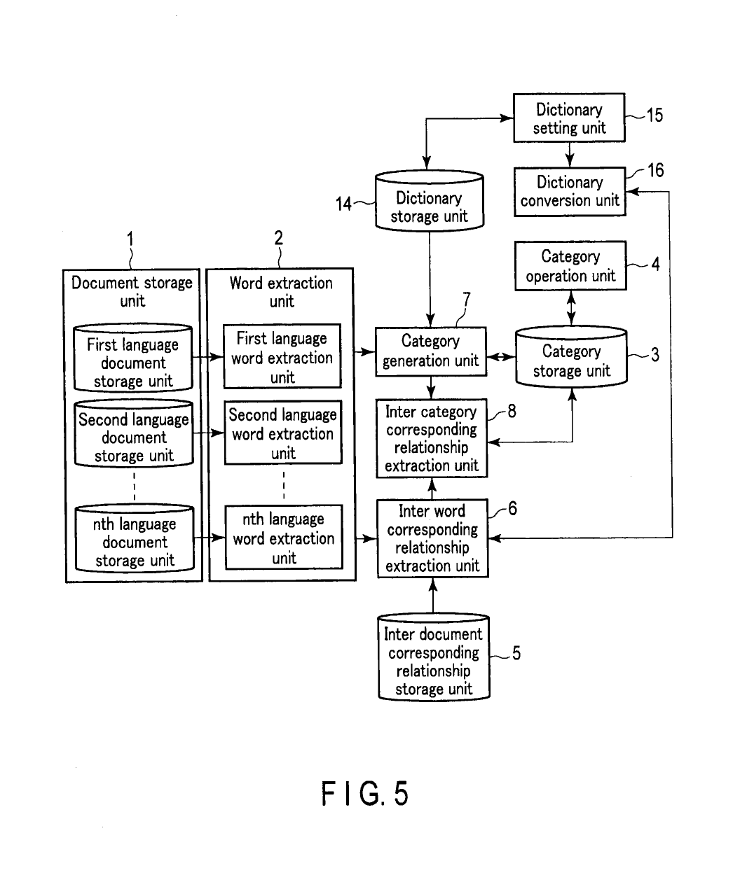

In an arrangement according to an embodiment shown in FIG. 5, a multilingual document classification apparatus includes a dictionary storage unit 14, a dictionary setting unit 15, and a dictionary conversion unit 16, which are units configured to implement a function unique to the arrangement shown in FIG. 5, in addition to a document storage unit 1, a word extraction unit 2, a category storage unit 3, a category operation unit 4, an inter-document corresponding relationship storage unit 5, an inter-word corresponding relationship extraction unit 6, a category generation unit 7, and an inter-category corresponding relationship extraction unit 8 shown in FIG. 1. FIG. 5 shows an example in which the dictionary storage unit 14, the dictionary setting unit 15, and the dictionary conversion unit 16 are added to the arrangement shown in FIG. 1. However, the dictionary storage unit 14, the dictionary setting unit 15, and the dictionary conversion unit 16 may be added to the arrangements shown in FIGS. 2, 3, and 4. The dictionary setting unit 15 and the dictionary conversion unit 16 are implemented by the processor.

That is, the dictionary storage unit 14 stores a dictionary that defines a word use method in the processing of the category generation unit 7 shown in FIG. 1, the case-based document classification unit 9 shown in FIG. 2, or the category feature word extraction unit 10 shown in FIG. 3. The dictionary storage unit 14 is implemented by a storage device, for example, a nonvolatile memory.

According to the embodiment shown in FIG. 5, for a dictionary defining important words, unnecessary words (stop words), and synonyms and used in automatic category generation or automatic document classification processing, the multilingual document classification apparatus can automatically convert a dictionary word described in a certain language into a dictionary word described in another language. This reduces the operation of causing the user to create and maintain the dictionaries.

As will be described later, one or a plurality of types of important words that are words on which importance is placed, unnecessary words that are words to be neglected, and synonyms that are combinations of words regarded as identical in processing such as document classification and category feature word extraction can be set as dictionary words in each dictionary stored in the dictionary storage unit 14. The dictionary setting unit 15 sets the dictionary words in the dictionary.

The dictionary conversion unit 16 converts a dictionary word described in a certain language and set in a dictionary into a dictionary word described in another language based on the corresponding relationship between words described in different languages, which is extracted by the inter-word corresponding relationship extraction unit 6.

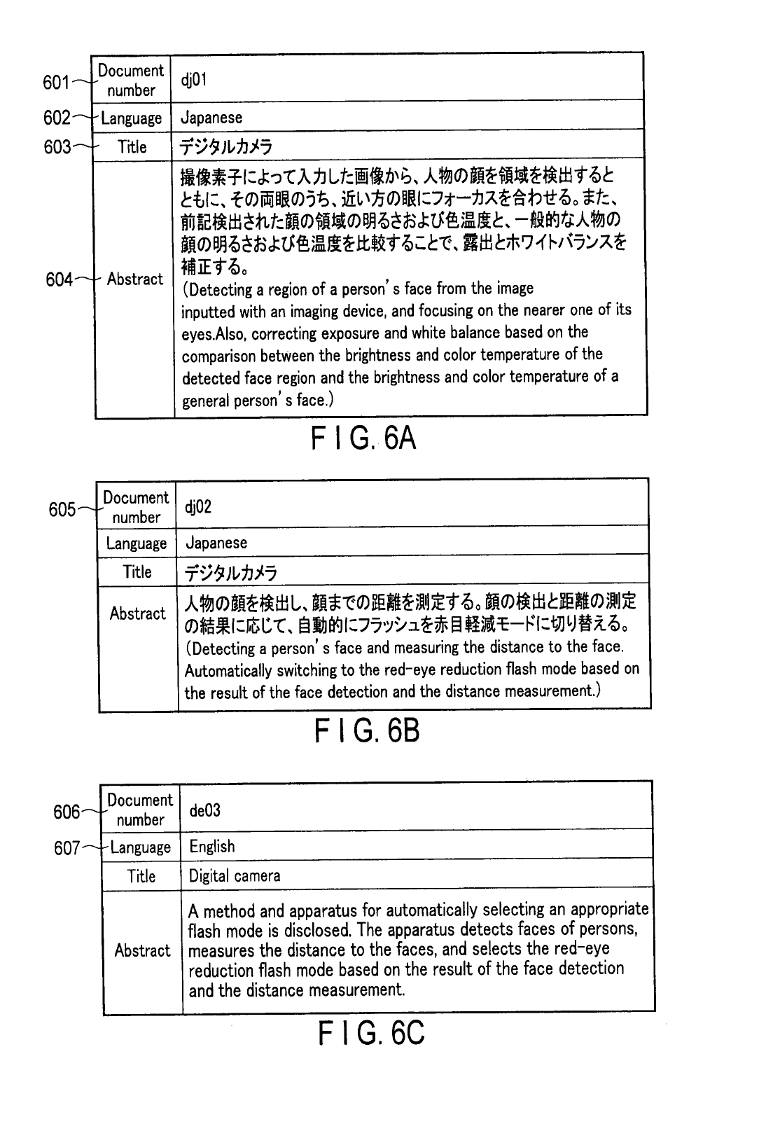

FIGS. 6A, 6B, and 6C are views showing, in a table format, an example of data of documents stored in the document storage unit 1. In the example of data of a total of three documents shown in FIGS. 6A, 6B, and 6C, a row 601 shown in FIG. 6A gives a unique document number “dj01”. A row 605 shown in FIG. 6B gives a unique document number “dj02”. A row 606 shown in FIG. 6C gives a unique document number “de03”.

As the language that describes the document, a row 602 shown in FIG. 6A sets “Japanese”, and a row 607 shown in FIG. 6C sets “English”. This example represents part of data of the abstracts of patents. Each document includes data of texts such as a title “ [symbol] ” (Digital camera) in a row 603 of FIG. 6A and an abstract “ [symbol] [symbol] , [symbol] [symbol] [symbol] . . . ” (Detecting a region of a person's face from the image inputted with an imaging device . . . ) in a row 604. In general, the documents are classified in accordance with the contents of the texts. However, the texts of the documents are described in different languages, as shown in FIGS. 6A, 6B, and 6C.

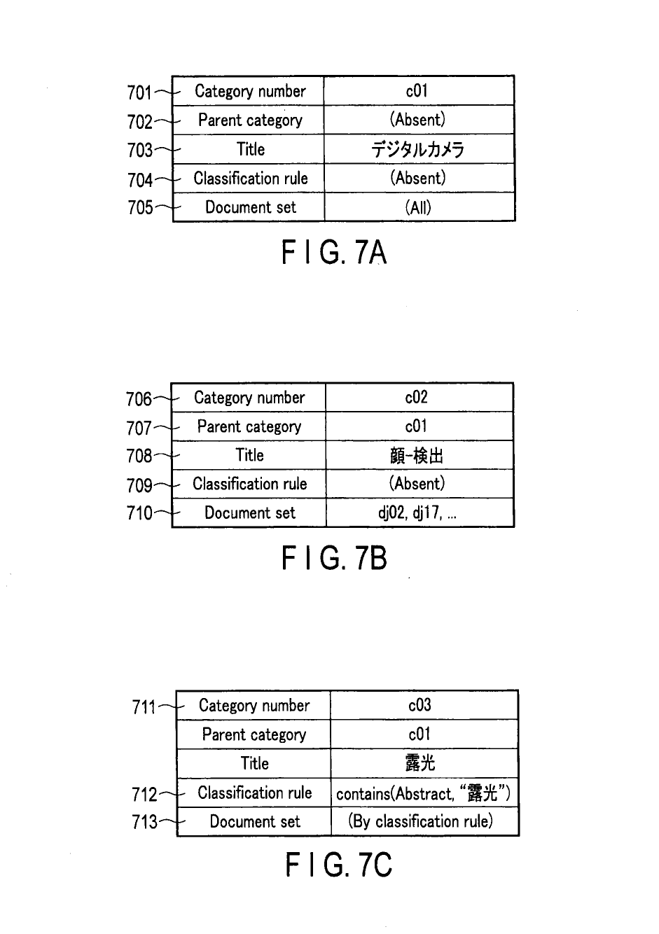

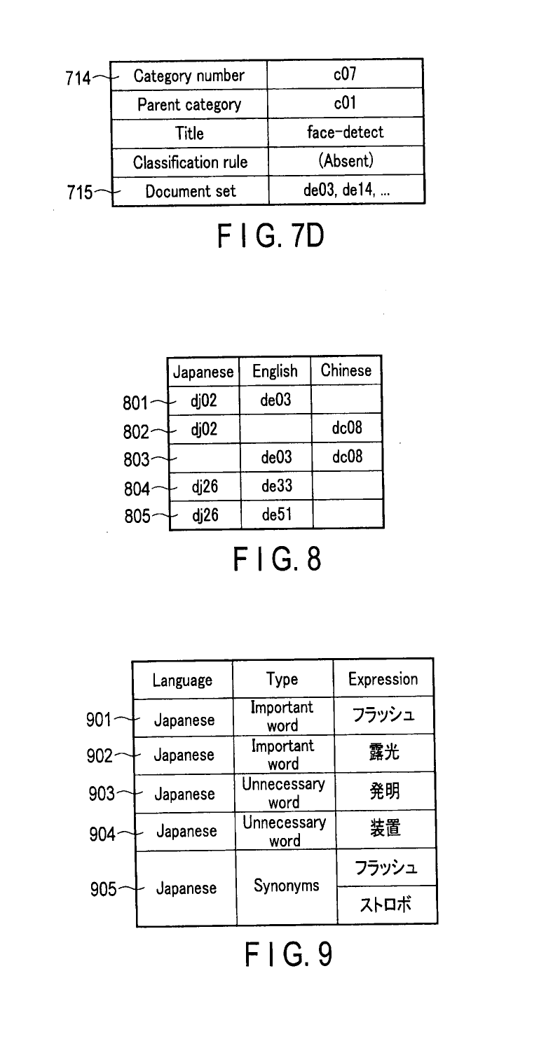

FIGS. 7A, 7B, 7C, and 7D are views showing an example of data of categories stored in the category storage unit shown in FIGS. 1, 2, 3, 4, and 5.

As shown in FIGS. 7A, 7B, 7C, and 7D, each category is given a unique category number, for example, a category number “c01” in a row 701 of FIG. 7A or a category number “c02” in a row 706 of FIG. 7B. The data of each category sets the relationship between the category and its parent category. A hierarchical structure formed from a plurality of categories is thus expressed.

For example, the parent category of the category shown in FIG. 7A is “(absent)” indicated by a row 702. Hence, this category is the uppermost, that is, the root category of the hierarchical structure.

The parent category of the category shown in FIG. 7B is “c01” indicated by a row 707. Hence, the category corresponding to the category number “c01” shown in FIG. 7A is the parent category of the category shown in FIG. 7B.

A title such as “ [symbol] ” (Digital camera) in a row 703 of FIG. 7A or “ [symbol] ” (face-detect) in a row 708 of FIG. 7B is set for each category. These titles are automatically added by the document classification apparatus or explicitly added by the user.

The data of each category sets documents classified into the category in the form of a classification rule or a document set. For example, in the category shown in FIG. 7A, the classification rule is “(absent)”, as indicated by a row 704, and the document set is “(all)”, as indicated by a row 705. For this reason, all documents stored in the document storage unit 1 are classified into this category.

In the category shown in FIG. 7B, the classification rule is “(absent)”, as indicated by a row 709, and document numbers such as “dj02” and “dj17” are set in the document set, as indicated by a row 710. For this reason, documents corresponding to these document numbers are classified into this category.

In the category shown in FIG. 7C, a classification rule “contains (abstract, “ [symbol] ” (exposure))” is set, as indicated by a row 712. By this classification rule, a document containing a word “ [symbol] ” (exposure) in the text of “abstract” of the document is classified into this category. Note that in the category shown in FIG. 7C, no document number is explicitly set in the document set, and instead, “(by classification rule)” is set, as indicated by a row 713, unlike the example of the row 710 shown in FIG. 7B. A document set by the classification rule is classified into this category.

Processing of classifying a document by a classification rule is executed by the rule-based document classification unit 12 shown in FIG. 4. However, this processing is generally executed by searching a storage unit such as a database for a document satisfying the classification rule. For example, if the classification rule is “contains (abstract, “ [symbol] ” (exposure))” in the row 712 of FIG. 7C, the multilingual document classification apparatus performs a full-text search for a document containing a word “ [symbol] ” (exposure) in the text of “abstract”, thereby obtaining a document to be classified into this category. This processing can be implemented by a conventional technique, and a detailed description thereof will be omitted.

FIG. 8 is a view showing an example of data of the corresponding relationship between documents stored in the inter-document corresponding relationship storage unit 5 shown in FIGS. 1, 2, 3, 4, and 5.

Each row such as a row 801 or a row 802 shown in FIG. 8 represents the corresponding relationship between documents on a one-to-one basis. For example, the row 801 indicates that a corresponding relationship holds between the document having the document number “dj02” and the document having the document number “de03”. That is, this represents the corresponding relationship between the Japanese document shown in FIG. 6B and the English document shown in FIG. 6C.

Similarly, the row 802 shown in FIG. 8 indicates that a corresponding relationship holds between the Japanese document having the document number “dj02” and a Chinese document having a document number “dc08”. According to a row 803, a corresponding relationship holds between the English document having the document number “de03” and the Chinese document having the document number “dc08”. This consequently indicates that all three documents, that is, the document having the document number “dj02”, the document having the document number “de03”, and the document having the document number “dc08” are associated with each other.

According to rows 804 and 805 shown in FIG. 8, a Japanese document having a document number “dj26” has a corresponding relationship with both an English document having a document number “de33” and an English document having a document number “de51”. As described above, the corresponding relationship can hold between one document and a plurality of documents in the same language (English in this case).

FIG. 9 is a view showing an example of data of a dictionary stored in the dictionary storage unit 14 shown in FIG. 5. In the dictionary stored in the dictionary storage unit 14, each row such as a row 901 or a row 902 shown in FIG. 9 indicates a dictionary word of the dictionary on a one-to-one basis. For example, the row 901 indicates a dictionary word that is an “important word” in “Japanese” and is expressed as “ [symbol] ” (flash). A row 903 indicates a dictionary word that is an “unnecessary word” in “Japanese” and is expressed as “ [symbol] ” (invention). A row 905 indicates a dictionary word that is a “synonym” in “Japanese” and is expressed as “ [symbol] ” (flash) or “ [symbol] ” (strobe).

An important word is a word on which importance is placed in processing such as document classification (to be described later). For example, when performing processing such as document classification by a method using word vectors, as in this embodiment, processing of, for example, doubling the weight of an important word in a word vector is performed. An unnecessary word is a word to be neglected in processing such as document classification. In this embodiment, processing of, for example, removing unnecessary words from word vectors and prohibiting them from being used as the dimensions of the word vectors is performed.

When classifying, for example, a patent document, a word such as “invention” or “apparatus” rarely represents the contents of the patent. For this reason, in this embodiment, such words are defined as unnecessary words, as shown in FIG. 9. A synonym is a word regarded as identical in processing such as document classification. In this embodiment, for example, even different expressions in word vectors are processed as the same word, that is, same dimension.

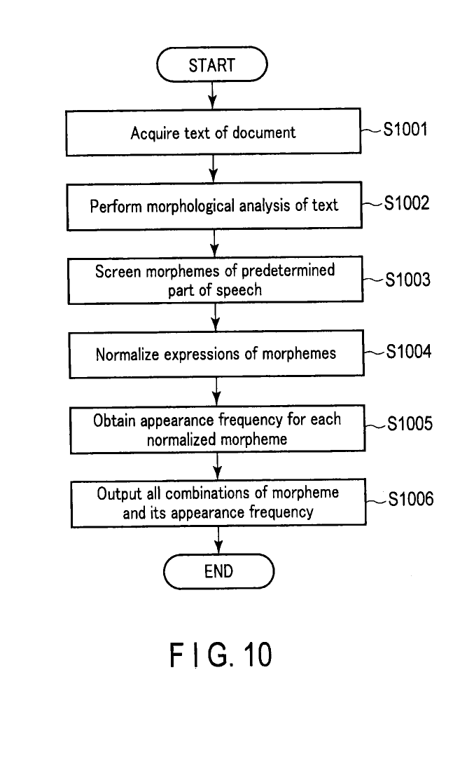

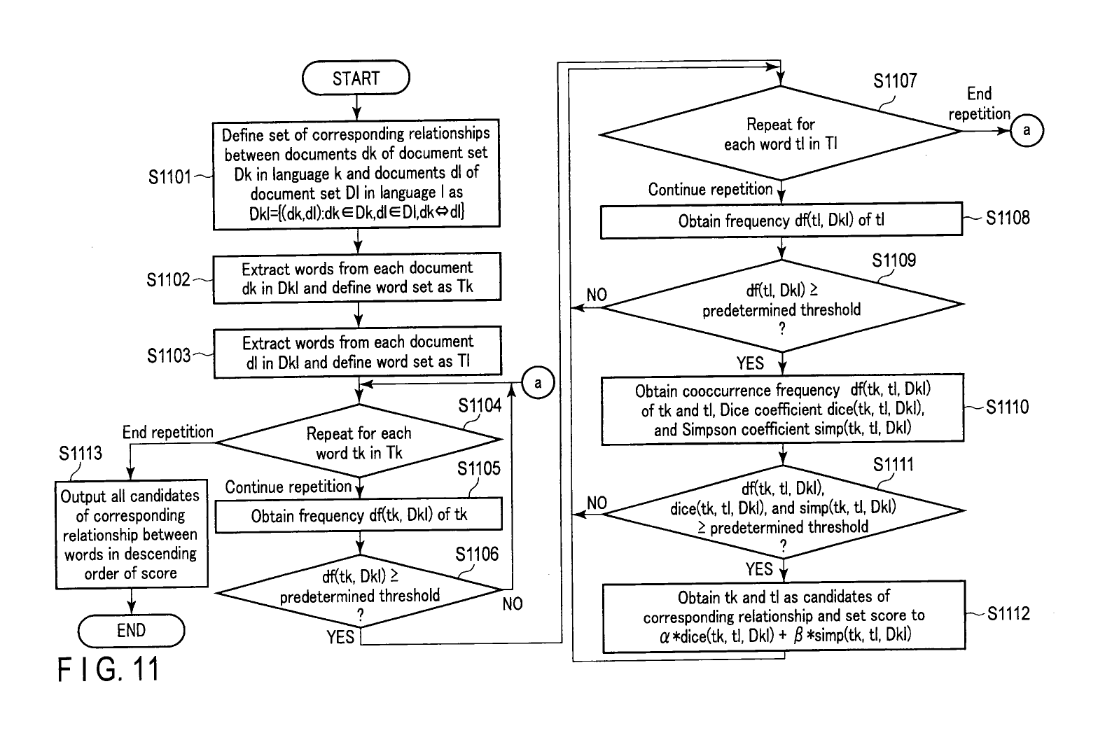

FIG. 10 is a flowchart showing an example of the procedure of processing of the word extraction unit 2 shown in FIGS. 1, 2, 3, 4, and 5.

First, the word extraction unit 2 acquires a text from a document as the target of word extraction (step S1001). In the example shown in FIGS. 6A, 6B, and 6C, the word extraction unit 2 acquires a text such as “ [symbol] [symbol] ” (Digital camera) that is the “title” of the document indicated by the row 603 of FIG. 6A or “ [symbol] [symbol] [symbol] [symbol] [symbol] [symbol] . . . ” (Detecting a region of a person's face from the image inputted with an imaging device . . . ) that is the “abstract” indicated by the row 604. The word extraction unit 2 performs morphological analysis of the acquired text (step S1002). Details of this processing change depending on the language. For example, when the text language is Japanese or Chinese, the word extraction unit 2 breaks down the text into morphemes, that is, separates the text by spaces, and adds a part of speech such as “noun” or “verb” to each morpheme. When the text language is English, the word extraction unit 2 performs the separation processing mainly based on blank characters. However, the word extraction unit 2 adds parts of speech as in Japanese or Chinese.

Next, the word extraction unit 2 screens the morphemes to which predetermined parts of speech are added, thereby leaving only necessary morphemes and removing unnecessary morphemes (step S1003). In general, the word extraction unit 2 performs processing of leaving an independent word or a content word as a morpheme used for processing such as classification and removing a dependent word or a function word. This processing depends on the language.

If a morpheme is, for example, an English or Chinese verb, the word extraction unit 2 can leave this morpheme as a necessary morpheme. If a morpheme is a Japanese verb, the word extraction unit 2 can remove this morpheme as an unnecessary morpheme. The word extraction unit 2 may remove an English verb such as “have” or “make” as a so-called stop word.

Next, the word extraction unit 2 normalizes the expressions of the morphemes (step S1004). This processing also depends on the language. For example, if the extracted text is Japanese, the word extraction unit 2 may absorb an expression fluctuation between “ [symbol] [symbol] ” (combination) and “ [symbol] ” (combination) or the like and handle them as the same morpheme. If the extracted text is English, the word extraction unit 2 may perform processing called stemming and handle morphemes including the same stem as the same morpheme.

The word extraction unit 2 obtains the appearance frequency (here, TF (Term Frequency)) in the document for each morpheme that is normalized in step S1004 (step S1005). Finally, the word extraction unit 2 outputs the combination of each morpheme normalized in step S1004 and its appearance frequency (step S1006).

FIG. 11 is a flowchart showing an example of the procedure of processing of the inter-word corresponding relationship extraction unit 6 shown in FIGS. 1, 2, 3, 4, and 5.

First, the inter-word corresponding relationship extraction unit 6 acquires data stored in the inter-document corresponding relationship storage unit 5. Using the data, the inter-word corresponding relationship extraction unit 6 defines the set of corresponding relationships between documents dk belonging to a document set Dk in a language k and documents dl belonging to a document set Dl in a language 1 as Dkl={(dk,dl):dkεDk, dlεDl, dk [symbol] dl} (step S1101).

Next, the inter-word corresponding relationship extraction unit 6 obtains the union of words extracted by the word extraction unit 2 from each of the documents dk in the language k in Dkl for all documents dk in Dkl, thereby obtaining a word set Tk in the language k (step S1102). As a result, words in the language k included in the documents in Dkl and their appearance frequencies (here, DF (Document Frequencies)) are obtained.

For the language l as well, the inter-word corresponding relationship extraction unit 6 obtains the union of words extracted by the word extraction unit 2 from each of the documents dl in the language l in Dkl for all documents dl in Dkl, thereby obtaining a word set Tl in the language l (step S1103). Then, the inter-word corresponding relationship extraction unit 6 repetitively (step S1104) performs the following processes of steps S1105 to S1112 for each word tk in the word set Tk.

The inter-word corresponding relationship extraction unit 6 obtains a document frequency df(tk, Dkl) of the word tk in Dkl (step S1105). If the document frequency is equal to or higher than a predetermined threshold (YES in step S1106), the inter-word corresponding relationship extraction unit 6 repetitively (step S1107) performs the following processes of steps S1108 to S1112 for each word tl in the word set Tl.

The inter-word corresponding relationship extraction unit 6 obtains a document frequency df(tl, Dkl) of the word tl (step S1108). If the document frequency is equal to or higher than the predetermined threshold (YES in step S1109), the inter-word corresponding relationship extraction unit 6 performs the following process from step S1110.

If the document frequency df(tk, Dkl) of the word tk, that is, the number of documents in which the word appears is smaller than the predetermined threshold (for example, smaller than 5) (NO in step S1106), the inter-word corresponding relationship extraction unit 6 returns to step S1104, based on the fact that data necessary to accurately obtain the corresponding relationship between the word and that described in another language is insufficient in Dkl.

If the document frequency df(tl, Dkl) of the word tl, that is, the number of documents in which the word appears is smaller than the predetermined threshold (for example, smaller than 5) (NO in step S1109), the inter-word corresponding relationship extraction unit 6 returns to step S1107, based on the fact that data necessary to accurately obtain the corresponding relationship between the word and that described in another language is insufficient in Dkl.

If the document frequency df(tl, Dkl) is equal to or higher than the predetermined threshold (YES in step S1109), the inter-word corresponding relationship extraction unit 6 obtains a cooccurrence frequency df(tk, tl, Dkl) of the words tk and tl in Dkl. The cooccurrence frequency is the number of corresponding relationships between documents including the word tk and documents including the word tl. Using the cooccurrence frequency, the inter-word corresponding relationship extraction unit 6 also obtains a Dice coefficient representing the magnitude of cooccurrence of the words tk and tl in Dkl by

dice(tk,tl,Dkl)=df(tk,tl,Dkl)/(df(tk,Dkl)+df(t,Dkl)) (1).

In addition, the inter-word corresponding relationship extraction unit 6 obtains a Simpson coefficient also representing the magnitude of cooccurrence in Dkl by

simp(tk,tl,Dkl)=df(tk,tl,Dkl)/min(df(tk,Dkl),df(tl,Dkl)) (2)(step S1110).

If each of the cooccurrence frequency df(tk, tl, Dkl), the Dice coefficient dice(tk, tl, Dkl), and the Simpson coefficient simp(tk, tl, Dkl) is equal to or more than a predetermined threshold (YES in step S1111), the inter-word corresponding relationship extraction unit 6 sets the relationship between the words tk and tl as a candidate of the corresponding relationship between the words. The inter-word corresponding relationship extraction unit 6 sets a score corresponding to the candidate of the corresponding relationship between the words to α*dice(tk,tl,Dkl)+β*simp(tk,tl,Dkl) (α and β are constants) (step S1112). Finally, the inter-word corresponding relationship extraction unit 6 outputs a plurality of thus obtained candidates of the corresponding relationship between the words in the descending order of score (step S1113).

In this embodiment, it is determined using the Dice coefficient and the Simpson coefficient based on the DF whether the relationship between the words tk and tl described in different languages is appropriate as equivalents or associated words. According to this method, the multilingual document classification apparatus can accurately extract the corresponding relationship between words using only a corresponding relationship on a document basis, that is, a rough corresponding relationship that is not a translation relationship on a sentence basis. However, this embodiment is not limited to the above-described method and equations, and another equation of, for example, a mutual information amount may be used, or a method considering the TF may be used.

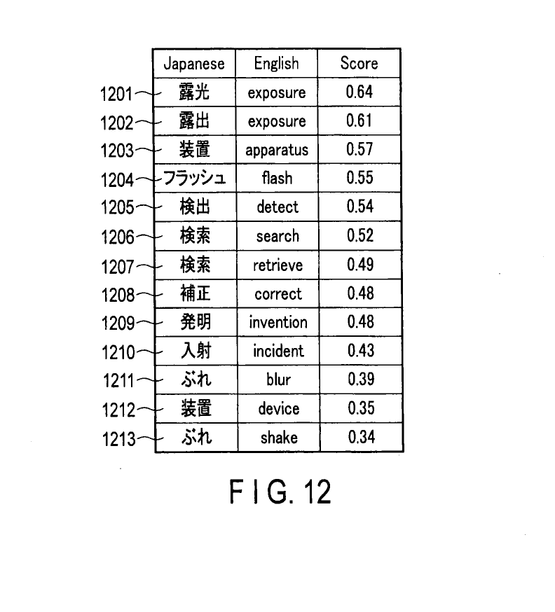

FIG. 12 is a view showing an example of the corresponding relationship between Japanese words and English words extracted as a result of processing of the inter-word corresponding relationship extraction unit 6 described with reference to FIG. 11.

As shown in FIG. 12, in, for example, a row 1201, an English word “exposure” corresponding to a Japanese word “ [symbol] ” is extracted and output together with a score. The multilingual document classification apparatus can obtain the corresponding relationship between one English word “exposure” and a plurality of Japanese words “ [symbol] ” and “ [symbol] ”, as in the examples of the row 1201 and a row 1202. Conversely, the multilingual document classification apparatus can also obtain a plurality of English words “search” and “retrieve” in correspondence with one Japanese word “ [symbol] [symbol] ”, as in the examples of a row 1206 and a row 1207.

The score added to the corresponding relationship between the words quantitatively indicates the degree of appropriateness of the corresponding relationship. Hence, the multilingual document classification apparatus can also selectively use, for example, only corresponding relationships of high scores, that is, corresponding relationships representing correct equivalents with a high possibility depending on the application purpose.

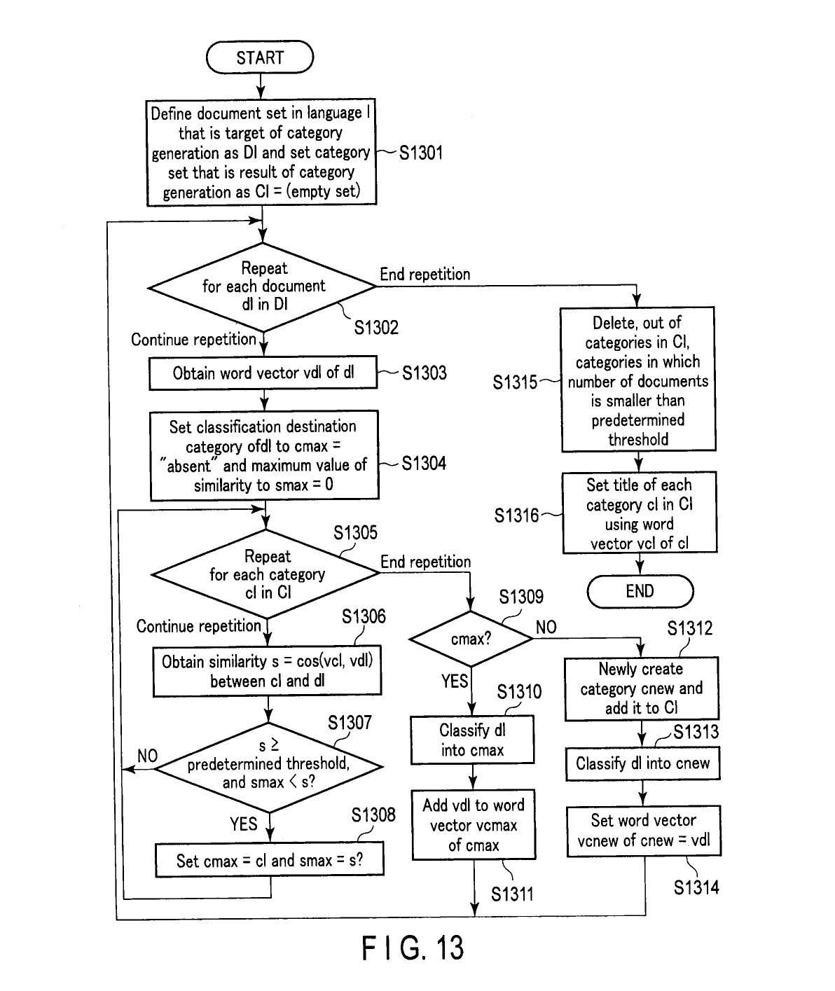

FIG. 13 is a flowchart showing an example of the procedure of processing of the category generation unit 7 shown in FIG. 1 or 5.

In this processing, clustering is performed for a document set described in a certain language, thereby automatically generating categories (clusters) each including documents of similar contents.

First, the category generation unit 7 defines a document set in the language l that is the target of category generation as Dl, and sets the initial value of a category set Cl that is the result of category generation as an empty set (step S1301). The category generation unit 7 repetitively (step S1302) executes the following processes of steps S1303 to S1314 for each document dl of the document set Dl.

The category generation unit 7 obtains a word vector vdl of the document dl by words extracted from the document dl by the word extraction unit 2 (step S1303). A word vector is a vector that uses each word appearing in a document as a dimension of the vector and has the weight of each word as the value of the dimension of the vector. This word vector can be obtained using a conventional technique. The weight of each word of the word vector can be calculated by a method generally called TFIDF, as indicated by, for example,

tfidf(tl,dl,Dl)=tf(tl,dl)*log(|Dl|/df(tl,Dl)) (3)

where tf(tl, dl) is the TF for the word tl in the document dl, and df(tl, Dl) is the DF for the word tl in the document set Dl. Note that tf(tl, dl) may simply be the appearance count of the word tl in the document dl. Alternatively, tf(tl, dl) may be, for example, a value obtained by dividing the appearance count of each word by the sum of the appearance counts of all words appearing in the document dl and normalizing the quotient.

When obtaining a word vector for a subset Dcl (Dcl⊂Dl) of certain documents, the category generation unit 7 can calculate the weight of the word tl of the word vector as the sum of the weights of the words tl of the word vectors of the documents dl in Dcl, as indicated by

tfidf(tl,Dcl,Dl)=(ΣdlεDcl(tf(tl,dl)))*log(|Dl|/df(tl,Dl)) (4).

Note that in the embodiment configured to use a dictionary, as described with reference to FIG. 5, the category generation unit 7 may perform processing of increasing the weight of an important word in the word vector, deleting an unnecessary word, or putting a plurality of words as synonyms into one dimension in step S1303.

Calculation in the category generation unit 7 is not limited to equation (3) or (4). More specifically, calculation for obtaining the weight of each word in the word vector suffices. If the same processing is performed, the calculation need not always be performed by the category generation unit 7.

Next, the category generation unit 7 sets the initial value of a classification destination category cmax of the document dl to “absent” and the initial value of a maximum value smax of the similarity between dl and cmax to 0 (step S1304). The category generation unit 7 repetitively (step S1305) executes the following processes of steps S1306 to S1308 for each category cl in the category set Cl.

The category generation unit 7 obtains a similarity s between the category cl and the document dl based on a cosine value cos(vcl, vdl) between a word vector vcl of the category cl and the word vector vdl of the document dl (step S1306).

If the similarity s is equal to or more than a predetermined threshold and more than smax (YES in step S1307), the category generation unit 7 sets cmax=cl and smax=s (step S1308).

If the category cmax exists (YES in step S1309) as the result of the repetitive process (step S1305), the category generation unit 7 classifies the document dl into the category cmax (step S1310). Then, the category generation unit 7 adds the word vector vdl of the document dl to a word vector vcmax of the category cmax (step S1311). As a result, a weight by the TF of the document dl is added to the weight of each word of the word vector vcmax, as indicated by equation (4).

On the other hand, if the category cmax does not exist (NO in step S1309), the category generation unit 7 newly creates a category cnew and adds it to the category set Cl (step S1312). The category generation unit 7 classifies the document dl into the category cnew (step S1313) and sets a word vector vcnew of the category cnew as the word vector vdl of the document dl (step S1314).

As the result of the repetitive process (step S1302), categories as the result of clustering the document set are generated in the category set Cl. The category generation unit 7 deletes, out of the generated categories, categories in which the number of documents is smaller than a predetermined threshold (step S1315). That is, for example, a category including only one document is meaningless. The category generation unit 7 removes such categories from the category generation result.

In addition, for each generated category cl, the category generation unit 7 sets the title of the category using the word vector vcl (step S1316). The category generation unit 7 sets the title by, for example, selecting one or a plurality of words of largest weights out of the word vectors of the category. For example, in the example shown in FIG. 7B, the category title “ [symbol] ” (face-detect) can be set using the two words “ [symbol] ” (face) and “ [symbol] ” (detect) indicated by the row 708. Each of the thus generated categories includes documents of a high word vector similarity. The processing described with reference to FIG. 13 is a clustering method generally called a leader-follower method. However, this embodiment is not limited to this method, and for example, a hierarchical clustering method, a k-means method, or the like may be used.

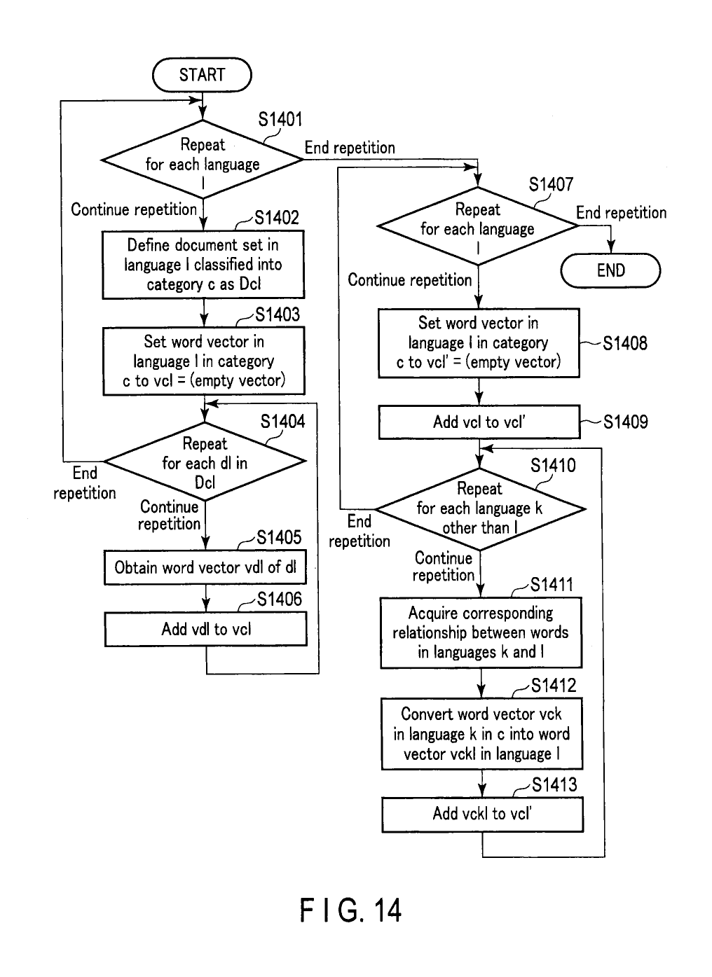

FIG. 14 is a flowchart showing an example of the procedure of processing of generating word vectors of a plurality of languages of a category.

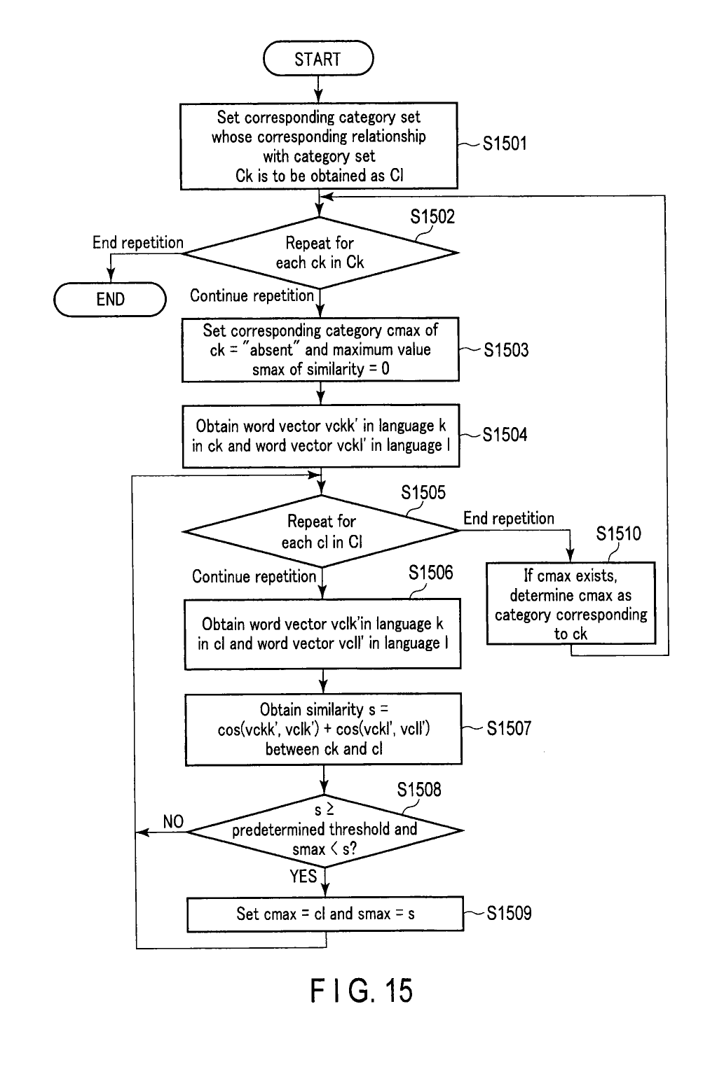

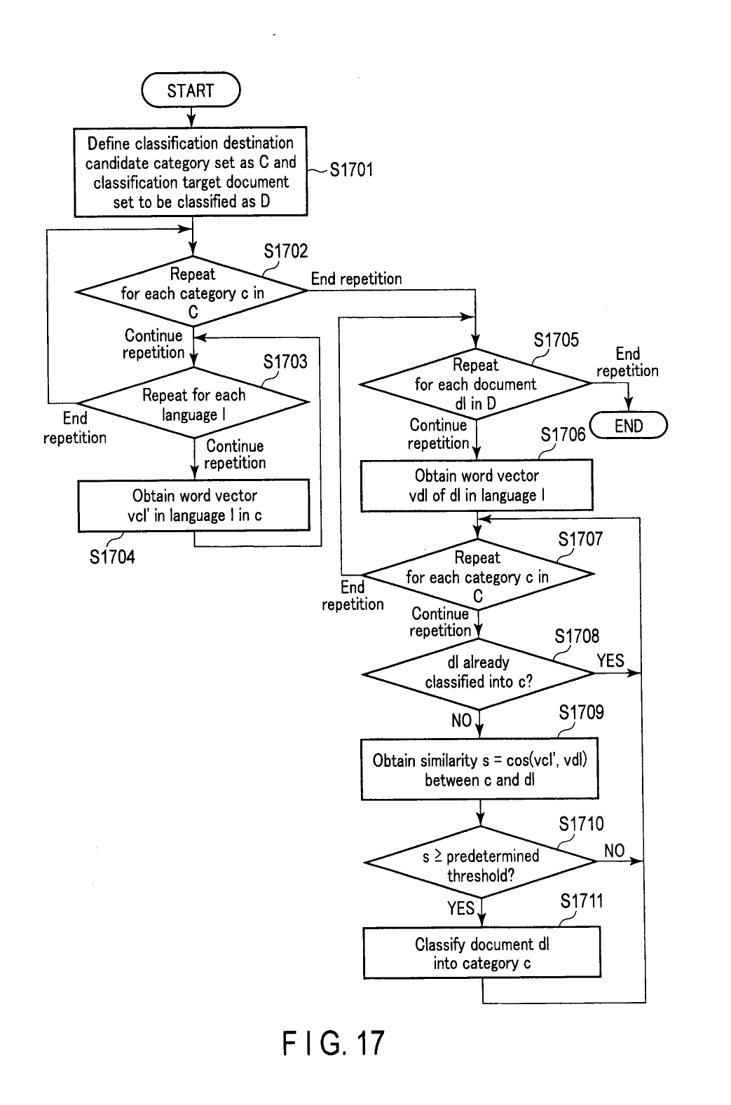

This processing is executed as the processes of step S1504 (inter-category corresponding relationship extraction unit 8) of FIG. 15 and step S1704 (case-based document classification unit 9) of FIG. 17 to obtain word vectors used in the processes shown in FIGS. 15 and 17 (to be described later). The language of documents classified into a category changes depending on the category. For example, only Japanese documents may be classified into a certain category, and a number of English documents and a few Chinese documents may be classified into another category.

To determine the similarity of contents between such various categories, processing shown in FIG. 14 aims at generating English or Chinese word vectors based on a category into which, for example, only Japanese documents are classified.

Note that in the first embodiment corresponding to FIG. 1, the inter-category corresponding relationship extraction unit 8 executes the following processing, and in the second embodiment corresponding to FIG. 2, the case-based document classification unit 9 executes the following processing. Hence, it will be pointed out explicitly in advance that “word vector generation processing” to be described below is processing executed by the inter-category corresponding relationship extraction unit 8 or the case-based document classification unit 9.

In the word vector generation processing, first, the multilingual document classification apparatus repetitively (step S1401) executes the following processes of steps S1402 to S1406 for each language l out of a plurality of languages. In the word vector generation processing, the multilingual document classification apparatus defines a document set in the language l classified into a category c as Dcl (step S1402). In the word vector generation processing, the document set Dcl may be an empty set depending on the category c and the type of the language l. Next, in the word vector generation processing, the multilingual document classification apparatus sets the initial value vcl of a word vector in the language l in the category c to an empty vector (all dimensions have a weight 0) (step S1403).

Next, in the word vector generation processing, the multilingual document classification apparatus repetitively (step S1404) obtains the word vector vdl of the document dl for each document dl in the document set Dcl (step S1405). In the word vector generation processing, the multilingual document classification apparatus adds the word vector vdl of the document dl to the word vector vcl in the language l in the category c (see equation (4)) (step S1406). In the above-described way, the word vectors in each language l are generated first based on the document set Dcl itself in the language l, which is actually classified into the category c. However, if the document set Dcl is an empty set, as described above, the word vectors vcl are empty vectors as well.

Next, in the word vector generation processing, the multilingual document classification apparatus repetitively (step S1407) executes the following processes of steps S1408 to S1413 again for each language l out of the plurality of languages. In the word vector generation processing, the multilingual document classification apparatus sets a word vector vcl′ in the language l in the category c to an empty vector (step S1408). The word vector vcl′ is different from the word vector vcl obtained in step S1405. In the word vector generation processing, first, the word vector vcl is added to the word vector vcl′ (step S1409).

Next, in the word vector generation processing, the multilingual document classification apparatus repetitively (step S1410) executes the following processes of steps S1411 to S1413 for each language k other than the language l. In the word vector generation processing, the multilingual document classification apparatus acquires the corresponding relationship between words in the languages k and l by the processing shown in FIG. 10 using the inter-word corresponding relationship extraction unit 6 shown in FIGS. 1, 2, 3, 4, and 5 (step S1411).

Then, in the word vector generation processing, the multilingual document classification apparatus converts a word vector vck in the language k in the category c into a word vector vckl in the language l (step S1412). In the corresponding relationship between words acquired in step S1411, the word tk in the language k, the word tl in the language l, and the score of the corresponding relationship between them are obtained, as described with reference to FIG. 12. Hence, in the word vector generation processing, the multilingual document classification apparatus acquires a weight weight(vck, tk) of the word tk of the word vector vck in the language k and a score score(tk, tl) of the corresponding relationship between the words tk and tl by

weight(vckl,tl)=Σₜₖ(weight(vck,tk)*score(tk,tl)) (5).

Using the acquired result, the multilingual document classification apparatus obtains the weight of the word tl of the word vector vckl in the language l.

Here, the weight weight(vck, tk) of the word tk of the word vector vck may be TFIDF described concerning equation (4). The score score(tk, tl) of the corresponding relationship between the words tk and tl may be α*dice(tk,tl,Dkl)+β*simp(tk,tl,Dkl) described with reference to FIG. 11. Note that if the word tk in the language k corresponding to the word tl does not exist, the weight of the word tl of the word vector vckl is 0. However, the weights of all dimensions of the word vector need not always have values larger than 0.

In the word vector generation processing, the multilingual document classification apparatus thus adds the word vector vckl obtained by converting the word vector in the language k into the language l to the word vector vcl′ (step S1413).

The word vectors vcl′ in the language l in the category c are generated by the repetitive process of step S1410. Additionally, the word vectors in all languages in the category c are generated by the repetitive process of step S1407.

As is apparent from the above explanation, even for a category into which, for example, only Japanese documents are classified, the multilingual document classification apparatus can generate a word vector in English or a word vector in Chinese using the corresponding relationship between a Japanese word and an English word or the corresponding relationship between a Japanese word and a Chinese word.

The processing from step S1408 to step S1413 of FIG. 14 is processing of generating the word vector vcl′ based on the word vector vcl in each language l. Hence, the multilingual document classification apparatus can further increase the dimensions based on the word vector vcl′ in each language and generate a word vector vcl″ of a sophisticated weight by modifying the processing of FIG. 14 and recursively executing the processes of steps S1408 to S1413. That is, the multilingual document classification apparatus can also generate the word vector vcl″ from the word vectors vcl′ and vck′, as in generating the word vector vcl′ from the word vectors vcl and vck.

FIG. 15 is a flowchart showing an example of the procedure of processing of the inter-category corresponding relationship extraction unit 8 shown in FIG. 1 or 5.

This processing extracts the corresponding relationship between each category cl of a certain category set Cl and each category ck of another category set Ck. In particular, this processing aims at extracting a corresponding relationship based on the similarity of contents between categories into which documents described in different languages are classified. The languages of documents classified into the categories of the category sets Ck and Cl are not particularly limited in the processing of FIG. 15. In general, however, the main processing target is a set of categories into which documents in a single language (the language k for the category set Ck and the language 1 for the category set Cl) generated by the category generation unit 7 shown in FIGS. 1, 2, 3, 4, and 5 in the processing shown in FIG. 13 are placed.

The inter-category corresponding relationship extraction unit 8 sets the corresponding category set whose corresponding relationship with the category set Ck is to be obtained as Cl (step S1501). The inter-category corresponding relationship extraction unit 8 repetitively (step S1502) executes the following processes of steps S1503 to S1509 for each category ck of the category set Ck.

First, the inter-category corresponding relationship extraction unit 8 sets the initial value of the category cmax corresponding to the category ck to “absent”, and sets the maximum value smax of the similarity between the categories ck and cmax to 0 (step S1503).

Next, the inter-category corresponding relationship extraction unit 8 obtains a word vector vckk′ in the language k in the category ck and a word vector vckl′ in the language l (step S1504). The process of step S1504 is performed by the processing described with reference to FIG. 14. Next, the inter-category corresponding relationship extraction unit 8 repetitively (step S1505) executes the following processes of steps S1506 to S1509 for each category cl of the category set Cl.

The inter-category corresponding relationship extraction unit 8 first obtains the word vector vclk′ in the language k in the category cl and a word vector vcll′ in the language l (step S1506). The process of step S1506 is performed by the processing described with reference to FIG. 14, like the process of step S1504.

The inter-category corresponding relationship extraction unit 8 then obtains the similarity between the categories ck and cl as s=cos(vckk′, vclk′)+cos(vckl′, vcll′) using the word vectors obtained in steps S1504 and S1506 (S1507). That is, the inter-category corresponding relationship extraction unit 8 obtains the similarity between the categories by the sum of the cosine value between the word vectors in the language k and the cosine value between the word vectors in the language l.

If the similarity s is equal to or more than a predetermined threshold and more than smax (YES in step S1508), the inter-category corresponding relationship extraction unit 8 sets category cmax=cl and smax=s (step S1509). If the category cmax exists after the repetitive process of step S1505, the inter-category corresponding relationship extraction unit 8 determines the category cmax as the category corresponding to the category ck (step S1510). That is, the inter-category corresponding relationship extraction unit 8 obtains cmax as the category assumed to have contents most similar to those of the category ck out of the category set Cl. In this case, the similarity (score) of the corresponding relationship is smax.

Note that although the score of the corresponding relationship between the categories ck and cl is obtained as the sum of the word vectors in the languages k and l in step S1507, the method of obtaining the score is not limited to this. For example, the inter-category corresponding relationship extraction unit 8 may calculate the score as the maximum value of the cosine value between the word vectors in the language k and the cosine value between the word vectors in the language l, that is, s=max(cos(vckk′, vclk′), cos(vckl′, vcll′)).

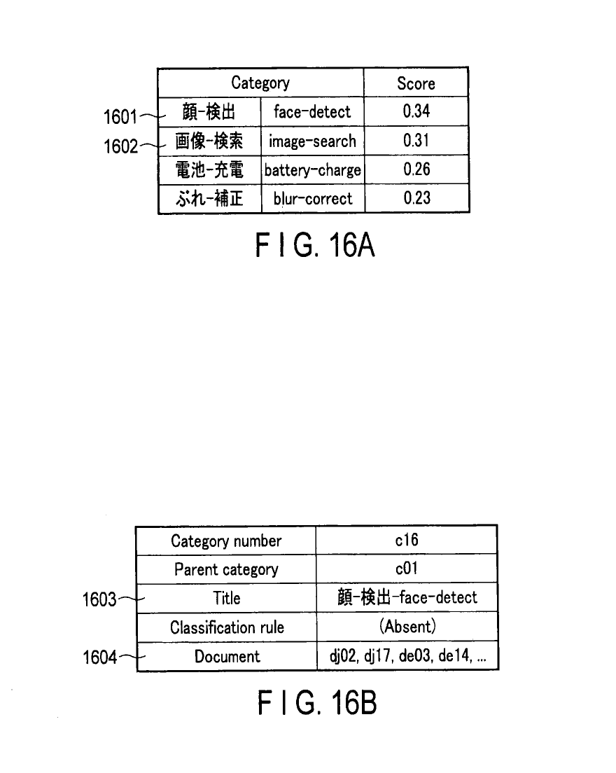

FIG. 16A is a view showing an example of the relationship between categories extracted by the processing of FIG. 15.

Each row such as a row 1601 or a row 1602 in FIG. 16A indicates the titles of categories (in this example, Japanese category and English category) whose corresponding relationship has been obtained and the similarity obtained in step S1507 of FIG. 15 as the score of the corresponding relationship.

As described concerning step S1316 of FIG. 13, for each category automatically generated by the processing of FIG. 13, a category title is set using a word that often appears in the documents classified into the category. Hence, the user can easily confirm whether the automatically extracted corresponding relationship between the categories is appropriate by using category titles (“ [symbol] ” and “face-detect”) as the result indicated by the row 1601 shown in FIG. 16A, category titles (“ [symbol] ” and “image-search”) as the result indicated by the row 1602 shown in FIG. 16A, or the score of the corresponding relationship.

The categories for which an appropriate corresponding relationship has been obtained may be integrated using the category operation unit 4 shown in FIGS. 1, 2, 3, 4, and 5. FIG. 16B shows a result of integrating the two categories of the row 1601 in FIG. 16A for instance. The two categories are the category shown in FIG. 7B and the category shown in FIG. 7D.

In this example, the category titles are connected in the form of “ [symbol] -face-detect”, as indicated by a row 1603 in FIG. 16B. In addition, as indicated by a row 1604 in FIG. 16B, the document set classified into the categories is the union of the document set indicated by the row 710 in FIG. 7B and the document set indicated by the row 715 in FIG. 7D. Japanese and English documents are thus classified.

According to this arrangement, for example, when classifying a document set in which Japanese documents, English documents, and Chinese documents coexist, a classification structure used to cross-lingually classify these documents based on the similarity between the contents can efficiently be created. That is, the multilingual document classification apparatus first performs clustering of the document set of Japanese, English, and Chinese documents separately on a language basis and automatically generates categories to classify the documents of similar contents in each language.

Next, the multilingual document classification apparatus extracts the corresponding relationship between words described in different languages based on the corresponding relationship between documents described in different languages. Here, the corresponding relationship between documents described in different languages is an equivalent relationship or a relationship close to it. As a detailed example, when classifying patent documents, for example, the corresponding relationship between a Japanese patent and a U.S. patent in right of priority or international patent application is extracted.

As the extracted corresponding relationship between words, for example, a corresponding relationship close to an equivalent relationship like the corresponding relationship between a Japanese word “ [symbol] ”, an English word “character”, and a Chinese word “ [symbol] ” is automatically obtained. The multilingual document classification apparatus automatically extracts the corresponding relationship between categories described in different languages based on the corresponding relationship between words.

The multilingual document classification apparatus cross-lingually integrates the categories whose corresponding relationship has been obtained, thereby creating categories to classify documents of similar contents independently of the languages such as Japanese, English, and Chinese.

Processing according to the embodiment shown in FIG. 2 will be described next. FIG. 17 is a flowchart showing an example of the procedure of processing of the case-based document classification unit 9 shown in FIG. 2.

As a conventional technique, a case-based classification (automatic supervised classification) technique has been implemented. In this technique, using a document already classified into a category as a classification case (supervisor document), it is determined based on the document whether to classify an unclassified document into the category. However, according to the processing shown in FIG. 17 in the embodiment shown in FIG. 2, a document already classified into a category and an unclassified document for which whether to classify it into the category should be determined may be described in different languages.

In the procedure of the processing shown in FIG. 17, first, the case-based document classification unit 9 defines a category set as the classification destination candidate of a document as C and a document set to be classified as D (step S1701). The case-based document classification unit 9 repetitively (step S1702) obtains a word vector in each language for each category c of the category C. The case-based document classification unit 9 repetitively (step S1703) obtains the word vector vcl′ in the language l in the category c for each language l (step S1704). The processing is performed by the processing described with reference to FIG. 14.

Next, the case-based document classification unit 9 repetitively (step S1705) executes the following processes of steps S1706 to S1711 for each document dl (document described in the language l) of the document set D.

First, the case-based document classification unit 9 obtains the word vector vdl of the document dl in the language l (step S1706). This processing is performed by obtaining the weight of each word in the language l using equation (3).

Then, the case-based document classification unit 9 repetitively (step S1707) executes the following processes of steps S1708 to S1711 for each category c of the category C.

First, if the document dl is not classified into the category c yet (NO in step S1708), the case-based document classification unit 9 obtains the similarity s between the category c and the document dl as s=cos(vcl′,vdl) based on the cosine value of the word vectors (step S1709). The word vector vdl of the document dl is the word vector in the language l. For this reason, as the word vector of the category whose similarity to the document is to be obtained, the word vector vcl′ in the same language l is used. This is the word vector obtained for the language l by the case-based document classification unit 9 out of the word vectors obtained for the respective languages in step S1704.

If the similarity s is equal to or more than a predetermined threshold (YES in step S1710), the case-based document classification unit 9 classifies the document dl into the category c (step S1711). The processes of steps S1710 and S1711 can be modified. For example, a modification can be made such that the case-based document classification unit 9 classifies the document to one selected category having the maximum similarity or classifies the document to three categories at maximum selected in descending order of similarity.

In the processing of FIG. 17, word vectors in a plurality of languages are obtained particularly in steps S1703 and S1704 independently of the language of the document already classified into a category. Hence, using the word vectors, the case-based document classification unit 9 can select a classification destination category for any document independently of its language.

According to this arrangement, after several documents in the native language that the user can easily understand, for example, only Japanese documents are manually classified into a category, the multilingual document classification apparatus can automatically classify English or Chinese documents having similar contents into the category based on the classification case of the Japanese documents, that is, supervisor documents.

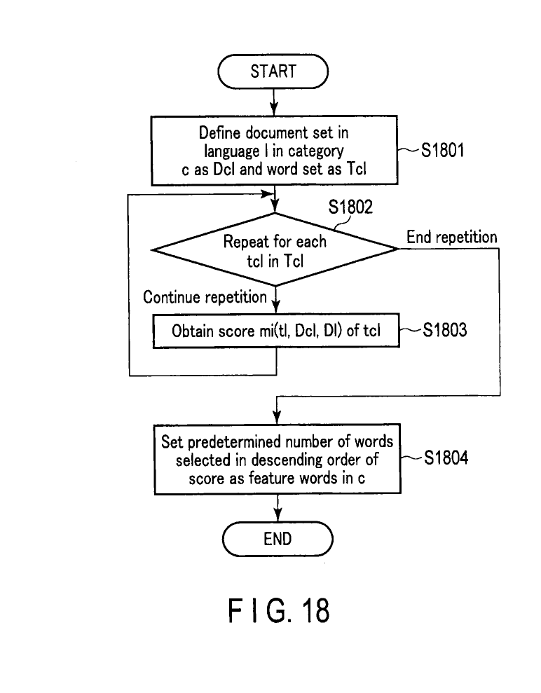

Processing according to the embodiment shown in FIG. 3 will be described next. FIG. 18 is a flowchart showing an example of the procedure of processing of the category feature word extraction unit 10 shown in FIG. 3.

A feature word of a category is a characteristic word representing the contents of documents classified into the category. The feature word is automatically extracted from each category for the purpose of, for example, allowing the user to easily understand what kind of documents are classified into each category.

In the processing shown in FIG. 18, first, letting c be the category as the feature word extraction target and l be the language of the extracted feature word, the category feature word extraction unit 10 defines a document set in the language l, which is classified into the category c, as Dcl, and a word set of words that appear in the documents of Dcl as Tcl (step S1801). The category feature word extraction unit 10 obtains the word set Tcl by obtaining the union of words extracted by the word extraction unit 2 shown in FIGS. 1, 2, 3, 4, and 5 from each document in the document set Dcl by the processing shown in FIG. 10 and totaling the document frequency (DF) of each word. This processing is the same as the process performed in, for example, step S1102 or S1103 of FIG. 11.

Next, for each word tcl of the word set Tcl, the category feature word extraction unit 10 repetitively (step S1802) obtains the score of tcl by

mi(t,Dcl,D)=df(t,Dcl)/|Dl|*log(df(t,Dcl)*|Dl|/df(t,Dl)/|Dcl|)+(df(t,Dl)−df(t,Dcl))/|Dl|*log((df(t,Dl)−df(t,Dcl))*|Dl|/df(t,Dl)/(|Dl|−|Dcl|))+(|Dcl|−df(t,Dcl))/|Dl|*log((|Dcl|−df(t,Dcl))*|Dl|/(|Dl|−df(t,Dl))/|Dl|)+(|Dl|−df(t,Dl)−|Dcl|+df(t,Dcl))/|Dl|*log((|Dl|−df(t,Dl)−|Dcl|+df(t,Dcl))*|Dl|/(|Dl|−df(t,Dl))/(|Dl|−|Dcl|)) (6)

(step S1803).

If df(t,Dcl)/df(t,Dl)≦|Dcl|/|Dl|, then mi(t,Dcl,Dl)=0

Here, using a mutual information amount, the category feature word extraction unit 10 obtains the score of the feature word based on the strength of correlation between an event representing whether a document has been classified into a category and an event representing whether the word tcl appears in the document. The event representing whether a document has been classified into a category equals an event representing whether a document is included in the document set Dcl.

Dl in equation (6) is the universal set (Dl⊃Dcl in general or Dl⊃Dcl in many cases) of documents described in the language l. A word and a category may have a negative correlation. To exclude this correlation, when df(tcl,Dcl)/df(tcl,Dl)≦|Dc|/|Dl|, the category feature word extraction unit 10 sets the score to 0, as indicated by the proviso of equation (6).

Finally, the category feature word extraction unit 10 selects a predetermined number of (for example, 10) words tcl in descending order of score, and sets the result as the feature words in the language l in the category c (step S1804).

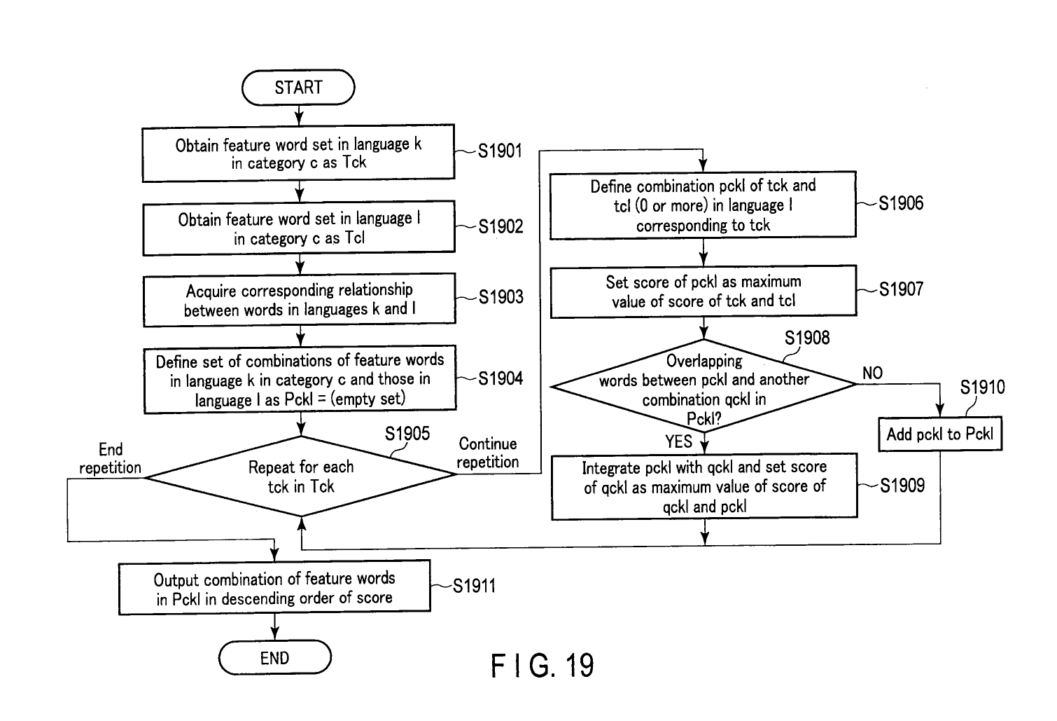

FIG. 19 is a flowchart showing an example of the procedure of processing of the category feature word conversion unit 11 shown in FIG. 3.

According to the processing described with reference to FIG. 18, for example, only Chinese feature words are obtained from a category into which only Chinese documents are classified. For this reason, it is difficult for a user whose native language is, for example, Japanese to understand the feature words. Hence, the multilingual document classification apparatus converts a feature word described in a certain language into a feature word described in another language by processing shown in FIG. 19.

In the processing shown in FIG. 19, the category feature word conversion unit 11 first obtains a feature word set Tck in the language k in the category c using the result of processing shown in FIG. 18 (step S1901). The processing of the category feature word conversion unit 11 aims at obtaining words in another language l corresponding to the feature word set Tck.

As in step S1901, the category feature word conversion unit 11 obtains a feature word set Tcl in the language l in the category c using the result of processing shown in FIG. 18 (step S1902). The process of step S1902 is not essential. If no document in the language l is classified into the category c from the start, the category feature word conversion unit 11 cannot obtain feature words in the language l. Hence, the feature word set Tcl is an empty set. A score is added to each feature word in the feature word sets Tck and Tcl, as described concerning step S1803 of FIG. 18.

Next, the corresponding relationship between words in the language k and those in the language l is obtained by the category feature word conversion unit 11 and the inter-word corresponding relationship extraction unit 6 (processing of FIG. 11) shown in FIGS. 1, 2, 3, 4, and 5 (step S1903). The category feature word conversion unit 11 defines the set of combinations of the feature words in the language k in the category c and those in the language l, which is the result of processing shown in FIG. 19, as Pckl, and sets the initial value to an empty set (step S1904).

The category feature word conversion unit 11 repetitively (step S1905) executes the following processes of steps S1906 to S1910 for each feature word tck of the feature word set Tck.

First, the category feature word conversion unit 11 obtains the word tcl in the language l corresponding to the feature word tck using the corresponding relationship between words acquired in step S1903. In general, 0 or more words tcl can exist. Hence, the category feature word conversion unit 11 defines a combination of the feature words tck and tcl as pckl, including a case where there exists no word tcl, that is, the word tcl does not exist (step S1906).

The category feature word conversion unit 11 obtains the score of pckl. The score of tck as a feature word is obtained by the process of step S1901.

The score of tck as a feature word is obtained when the feature word tcl is included in the feature word set Tcl obtained in step S1902. However, the score of the feature word tcl that is not included in the feature word set Tcl is 0. Considering the above case, the category feature word conversion unit 11 sets the score of pckl as the maximum value of the score of the feature word tck and the score of the feature word tcl (step S1907).

Next, the category feature word conversion unit 11 checks whether words in the language k or l overlap between an already created combination qckl and the combination pckl created this time in a set Pckl of feature word combinations (step S1908).

If qckl in which the words overlap exists (YES in step S1908), the category feature word conversion unit 11 integrates pckl into qckl. For example, when pckl=({tck1},{tcl1, tcl2}), and qck1=((tck2),(tcl2,tcl3)), feature words tcl2 in the language l overlap between pckl and qckl. Hence, the category feature word conversion unit 11 integrates them to obtain qckl=({tck1,tck2}, {tcl1,tcl2,tcl3}). The score of qckl after the integration is the maximum value (that is, the maximum value of the scores of feature words tck1, tck2, tcl1, tcl2, and tcl3) of qckl and pckl before the integration (step S1909).

On the other hand, if qckl in which the words overlap those of pckl does not exist (NO in step S1908), the category feature word conversion unit 11 adds pckl to Pckl (step S1910). After the repetitive process of step S1905, the category feature word conversion unit 11 outputs the combinations of feature words in Pckl in descending order of score (step S1911).

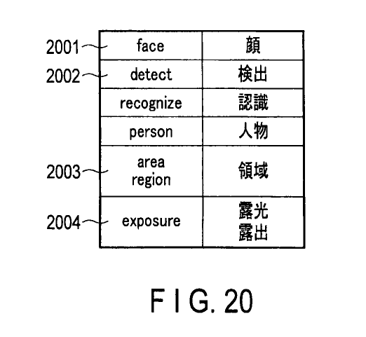

FIG. 20 is a view showing, in a table format, an example of feature words extracted by the category feature word extraction unit 10 (corresponding to the processing of FIG. 18) shown in FIG. 3 and converted by the category feature word conversion unit 11 (corresponding to the processing of FIG. 19).

As shown in FIG. 20, for example, an English feature word “face” is converted into a Japanese feature word “ [symbol] ”, as indicated by a row 2001. Similarly, an English feature word “detect” is converted into a Japanese feature word “ [symbol] ”, as indicated by a row 2002. In addition, for example, two English feature words “area” and “region” are associated with one Japanese feature word “ [symbol] ”, as indicated by a row 2003. Conversely, one English feature word “exposure” is associated with two Japanese feature words “ [symbol] ” and “ [symbol] ”, as indicated by a row 2004. When the thus converted feature words are used, the user can easily understand the contents of documents classified into categories in various languages. For example, when the corresponding relationship between the English feature words and the Japanese feature words as shown in FIG. 20 is presented to the user, he/she can easily know the meaning of a word described in an unfamiliar language.

According to this arrangement, from, for example, a category into which many Chinese documents are classified, a Chinese feature word is automatically extracted as the feature word of the category. Next, the feature word is automatically converted into a Japanese or English feature word. The user can use the feature word described in the language easy for him/her to understand and can therefore easily grasp the contents of the category.

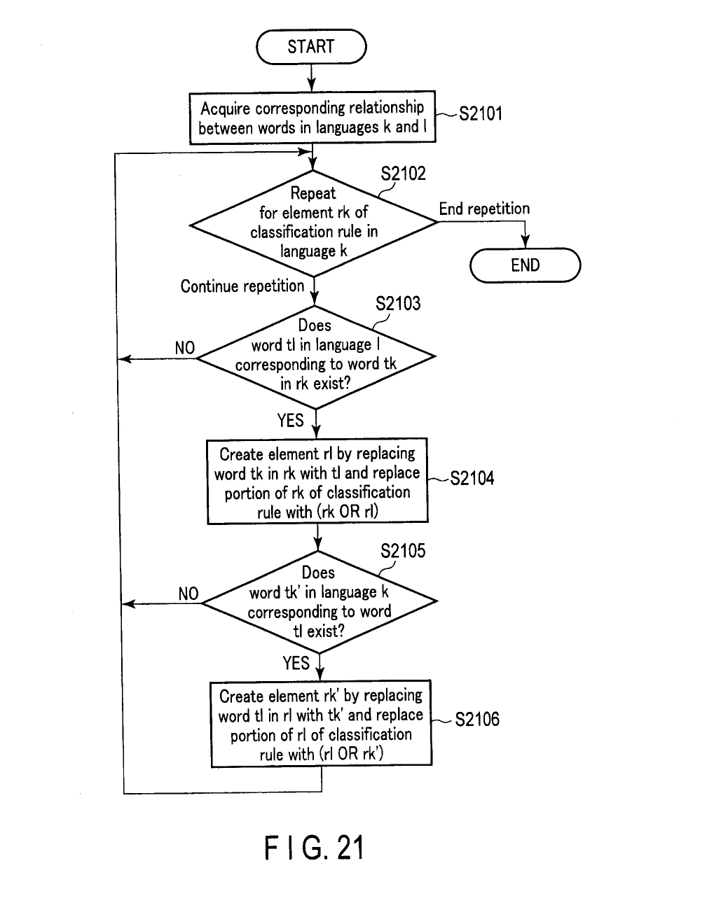

Processing according to the embodiment shown in FIG. 4 will be described next. FIG. 21 is a flowchart showing an example of the procedure of processing of the classification rule conversion unit 13 shown in FIG. 4.

As described with reference to FIG. 7C, using a classification rule, the multilingual document classification apparatus can classify documents according to an explicit condition that, for example, a word “ [symbol] ” (exposure) is included in the abstract of a document. However, for example, the word “ [symbol] ” (exposure) is only applicable for the purpose of classifying Japanese documents. That is, the word cannot be applied for the purpose of classifying English or Chinese documents. To cope with this, the classification rule conversion unit 13 converts a classification rule described in a certain language into a classification rule described in another language by processing shown in FIG. 21.

First, the classification rule conversion unit 13 acquires the corresponding relationship between words in the languages k and l from the inter-word corresponding relationship extraction unit 6 (corresponding to the processing of FIG. 11) shown in FIGS. 1, 2, 3, 4, 5, 6A, 6B, and 6C (step S2101).

Next, the classification rule conversion unit 13 repetitively (step S2102) executes the following processes of steps S2103 to S2106 for an element (in the example of FIG. 7C, Japanese element “contains (abstract, “ [symbol] ” (exposure))”) in the language k in the classification rule to be converted.

The classification rule conversion unit 13 first determines, using the corresponding relationship between words acquired in step S2101, whether the word tl in the language l corresponding to the word tk in an element rk of the classification rule exists (step S2103).

If the word tl exists (YES in step S2103), the classification rule conversion unit 13 creates an element rl by replacing the word tk of rk with the word tl (step S2104). In the example of FIG. 7C, the word tk is “ [symbol] ” (exposure), the word tl is “exposure”, the element rk before classification rule replacement is “contains (abstract, “ [symbol] ” (exposure))”, and the element rl after replacement is “contains (abstract, “exposure”)”. The classification rule conversion unit 13 replaces the portion of the element rk of the classification rule with an OR (rk OR rl).

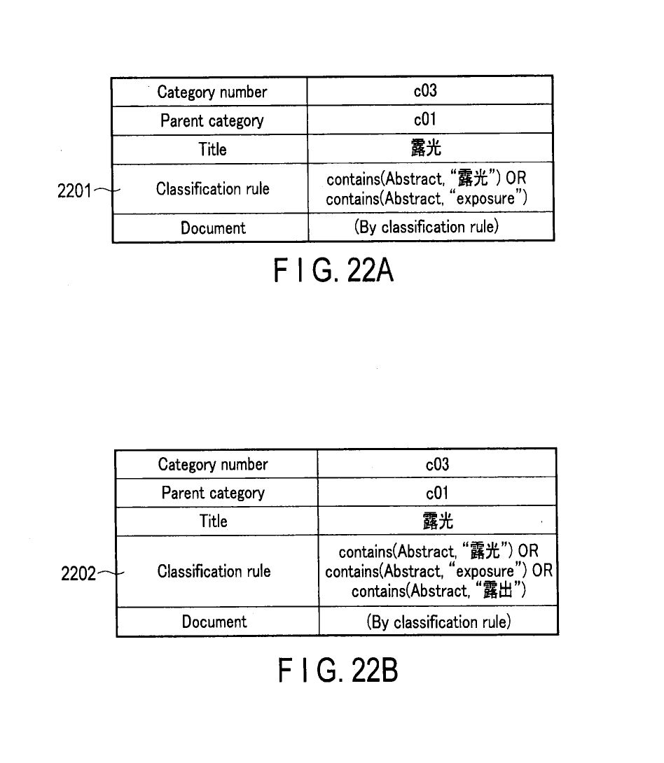

FIGS. 22A and 22B are views showing examples of a thus converted category classification rule. As the result of the process of step S2104, the classification rule indicated by the row 712 in FIG. 7C is converted into a classification rule indicated by a row 2201 in FIG. 22A.

In the process from step S2105 of FIG. 21, the classification rule conversion unit 13 extends the element in the language k in the classification rule. This processing is not essential. The classification rule conversion unit 13 determines, using the corresponding relationship between words acquired in step S2101, whether a word tk′ (word different from tk) in the language k corresponding to the word tl in the language l exists (step S2105).

If the word tk′ exists (YES in step S2105), the classification rule conversion unit 13 creates an element rk′ by replacing the word tl of the element rl created in step S2104 with the word tk′ (step S2106). In the example indicated by the row 712 of FIG. 7C, the word tl is “exposure”, the word tk′ is “ [symbol] ”, and the element rk′ of the classification rule is “contains (abstract, “ [symbol] ”)”.

The classification rule conversion unit 13 replaces the portion of rl of the classification rule with (rl OR rk′). In this case, the element rk of the original classification rule is eventually replaced with (rk OR rl OR rk′).

A classification rule indicated by a row 2202 of FIG. 22B is the finally obtained classification rule. This classification rule enables to classify not only Japanese documents but also English documents. Additionally, the classification rule allows all the Japanese documents to be classified, as compared to the original classification rule.

According to this arrangement, the multilingual document classification apparatus creates a classification rule to classify a document including, for example, a Japanese word “ [symbol] ” into a certain category and then converts the classification rule into English or Chinese. This makes it possible to classify a document including an equivalent or related term of the Japanese word “ [symbol] ”, for example, an English word “encrypt” or a Chinese word “ [symbol] ” into the category.

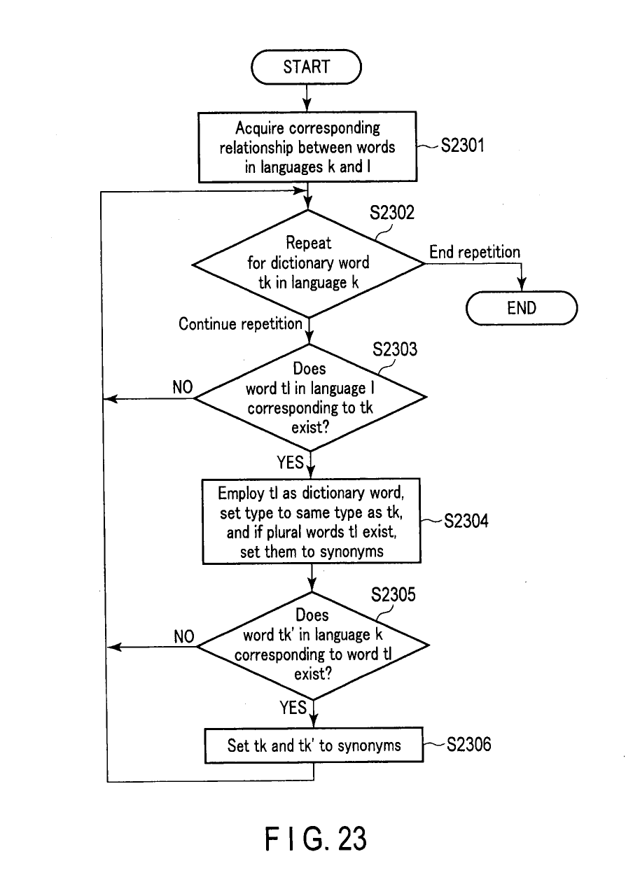

Processing according to the embodiment shown in FIG. 5 will be described next. FIG. 23 is a flowchart showing an example of the procedure of processing of the dictionary conversion unit 16 shown in FIG. 5.

As described with reference to FIG. 9 and concerning step S1303 of FIG. 13 or the like, documents can appropriately be classified in accordance with the contents using dictionary words such as an important word, an unnecessary word, and a synonym. However, when classifying a document described in a different language, an operation of creating a dictionary needs labor. In the processing of FIG. 23, the multilingual document classification apparatus automatically converts a dictionary word described in a certain language into a dictionary word described in another language, thereby easily creating dictionaries described in various languages.

In the processing shown in FIG. 23, first, the dictionary conversion unit 16 acquires the corresponding relationship between words in the languages k and l from the inter-word corresponding relationship extraction unit 6 (corresponding to the processing of FIG. 11) shown in FIGS. 1, 2, 3, 4, and 5 (step S2301). Next, the dictionary conversion unit 16 repetitively (step S2302) executes the following processes of steps S2303 to S2306 for the dictionary word tk in the language k to be converted.

The dictionary conversion unit 16 first determines, using the corresponding relationship between words acquired in step S2301, whether the word tl in the language l corresponding to the dictionary word tk exists (step S2303). If the word tl exists (YES in step S2303), the dictionary conversion unit 16 employs the word tl as a dictionary word. The dictionary conversion unit 16 sets the type (important word, unnecessary word, synonym, or the like) of the dictionary word to the same type as the dictionary word tk. If a plurality of words tl corresponding to the one dictionary word tk exist, the dictionary conversion unit 16 sets these words to synonyms (step S2304).

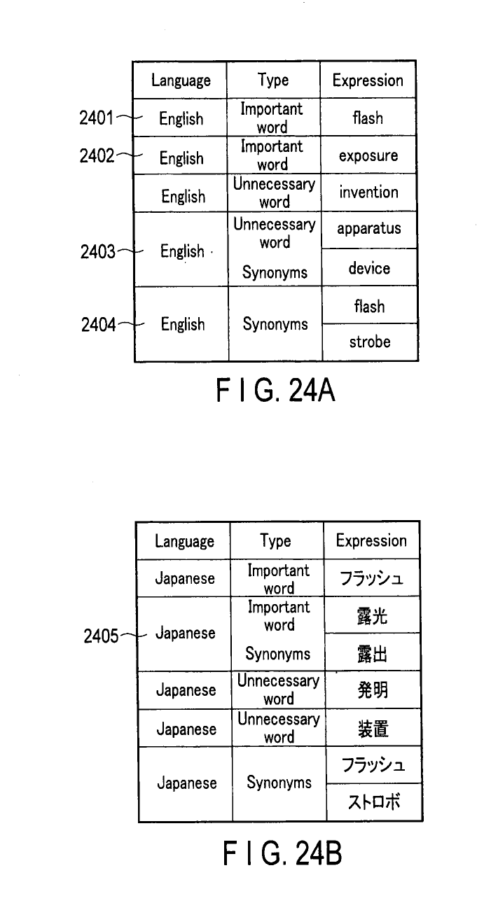

FIG. 24A is a view showing an example of a result of converting the Japanese dictionary shown in FIG. 9 into an English dictionary.

A row 2401 of FIG. 24A indicates that the Japanese important word “ [symbol] ” indicated by the row 901 of FIG. 9 is converted into an English important word “flash”.

A row 2402 of FIG. 24A indicates that the Japanese important word “ [symbol] ” (exposure) indicated by the row 902 of FIG. 9 is converted into an English important word “exposure”.

A row 2403 of FIG. 24A indicates that the Japanese unnecessary word “ [symbol] ” indicated by the row 904 of FIG. 9 is converted into two English words “apparatus” and “device”. These words are unnecessary words and synonyms, as indicated by the row 2403 of FIG. 24A.

As indicated by a row 2404 of FIG. 24A, the Japanese synonyms “ [symbol] ” and “ [symbol] ” indicated by the row 905 of FIG. 9 are converted into English words “flash” and “strobe” in terms of word (expression). For this reason, even in English, these words are synonyms indicated by the row 2404 of FIG. 24A.

Note that if only one word or less than one word is obtained as the result of conversion of synonyms (if no corresponding word exists in the conversion destination language or if the words are converted into a single word), the meaning as a synonym is lost. Hence, the dictionary conversion unit 16 may delete the synonym from the converted dictionary.

Next, the dictionary conversion unit 16 performs processing of extending the synonyms of the dictionary in the language k as the conversion source. This processing is not essential. The dictionary conversion unit 16 determines, using the corresponding relationship between words acquired in step S2301, whether the word tk′ (word different from tk) in the language k corresponding to the word tl in the language 1 exists (step S2305). If the word tk′ exists (YES in step S2305), the dictionary conversion unit 16 sets the original word tk and the word tk′ in the language k to synonyms (step S2306).

For example, the English important word “exposure” indicated by the row 2402 of FIG. 24A corresponds to the important word “ [symbol] ” indicated by the row 902 of FIG. 9. However, “exposure” also corresponds to the Japanese word “ [symbol] ”, as indicated by the row 1202 of FIG. 12. Hence, as a result, “ [symbol] ” and “ [symbol] ” are important words and synonyms in the Japanese dictionary, as indicated by a row 2405 of FIG. 24B. In this way, the multilingual document classification apparatus can not only automatically create, for example, an English dictionary by converting a Japanese dictionary but also add synonyms to the Japanese dictionary as well.

According to this arrangement, the multilingual document classification apparatus can efficiently create, for example, a dictionary suitable for classifying English or Chinese documents from a dictionary created for the purpose of appropriately classifying Japanese documents.

In the embodiments, the above-described functions can be implemented using only the corresponding relationship between documents described in different languages, which are documents included in the document set to be classified itself. It is therefore unnecessary to prepare a bilingual dictionary or the like in advance. In addition, when an existing general-purpose bilingual dictionary is used, appropriate equivalents need to be selected in accordance with the document to be classified. In this embodiment, however, a word corresponding relationship extracted from the document to be classified itself is used. Hence, the multilingual document classification apparatus need not select equivalents. Furthermore, the multilingual document classification apparatus can avoid using inappropriate equivalents.

As a consequence, the multilingual document classification apparatus can accurately implement processing of automatically extracting the cross-lingual corresponding relationship between categories or processing of automatically cross-lingually classifying a document. If the above-described classification rule or dictionary word is converted by a conventional method using a general-purpose bilingual dictionary, an inappropriate classification rule or dictionary word is often created. In this embodiment, such a problem does not arise, and the multilingual document classification apparatus can obtain a classification rule or dictionary word to appropriately classify the document to be classified.

While a certain embodiment has been described, this embodiment has been presented by way of example only, and is not intended to limit the scope of the inventions. Indeed, the novel embodiment described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A document classification apparatus comprising:
a document storage unit configured to store a plurality of documents in different languages;
an inter-document corresponding relationship storage unit configured to store a corresponding relationship between the documents in the different languages which are stored in the document storage unit;
a category storage unit configured to store a category to classify the plurality of documents stored in the document storage unit;
a word extraction unit configured to extract words from the documents stored in the document storage unit;
an inter-word corresponding relationship extraction unit configured to extract the corresponding relationship between the words extracted by the word extraction unit, using the corresponding relationship stored in the inter-document corresponding relationship storage unit and based on a frequency with which the words co-occurrently appear between the documents having the corresponding relationship;
a category generation unit configured to generate the category for each language by clustering, based on a similarity of the frequency with which the words extracted by the word extraction unit appear between the documents in the same language, which are stored in the document storage unit, the plurality of documents described in the language; and
an inter-category corresponding relationship extraction unit configured to extract the corresponding relationship between the categories into which the documents in the different languages are classified by regarding that the more inter-word corresponding relationships there are between a word that frequently appears in a document classified into a certain category and a word that frequently appears in a document classified into another category, the higher the similarity between the categories is, based on the frequency of the word that appears in the document classified into each category generated for each language by the category generation unit and the corresponding relationship extracted by the inter-word corresponding relationship extraction unit.

2. A document classification apparatus comprising:
a document storage unit configured to store a plurality of documents in different languages;
an inter-document corresponding relationship storage unit configured to store a corresponding relationship between the documents in the different languages which are stored in the document storage unit;
a category storage unit configured to store a category to classify the plurality of documents stored in the document storage unit;
a word extraction unit configured to extract words from the documents stored in the document storage unit;
an inter-word corresponding relationship extraction unit configured to extract the corresponding relationship between the words extracted by the word extraction unit, using the corresponding relationship stored in the inter-document corresponding relationship storage unit and based on a frequency with which the words co-occurrently appear between the documents having the corresponding relationship; and
a case-based document classification unit configured to determine, based on one or a plurality of classified documents that are documents already classified into the category stored in the category storage unit, whether to classify, into the category, an unclassified document yet to be classified into the category,
wherein the case-based document classification unit determines, when the similarity between a word that frequently appears in a classified document of a certain category and a word that frequently appears in a certain unclassified document meets a predetermined condition and is high, whether to classify, into a category, the unclassified document described in a language different from the language that describes the classified document of the category, based on the frequency with which the words extracted by the word extraction unit appear for each of the classified documents and the unclassified documents of each category and the corresponding relationship extracted by the inter-word corresponding relationship extraction unit.

3. The document classification apparatus according to claim 1, further comprising:
a category feature word extraction unit configured to extract a feature word of the category based on the frequency with which the words extracted by the word extraction unit appear for one or a plurality of documents described in one or a plurality of languages, which are the documents classified into the category stored in the category storage unit; and
a category feature word conversion unit configured to convert the feature word described in a first language, which is the feature word extracted by the category feature word extraction unit, into a feature word described in a second language based on the corresponding relationship extracted by the inter-word corresponding relationship extraction unit.

4. The document classification apparatus according to claim 1, further comprising:
a rule-based document classification unit configured to determine a category, out of one or a plurality of categories stored in the category storage unit, to classify the documents stored in the document storage unit, based on a classification rule that defines to classify a document in which one or a plurality of words extracted by the word extraction unit appears to the category; and
a classification rule conversion unit configured to convert the classification rule by converting a word described in a first language in the classification rule of each category used by the rule-based document classification unit into a word described in a second language based on the corresponding relationship extracted by the inter-word corresponding relationship extraction unit.

5. The document classification apparatus according to claim 1, further comprising:
a dictionary storage unit configured to store a dictionary used to define a word use method of the category generation unit;
a dictionary setting unit configured to set one or some of an important word on which importance is placed, an unnecessary word to be neglected, and synonyms regarded as identical as a dictionary word in the dictionary; and
a dictionary conversion unit configured to convert a dictionary word described in a certain language, which is the dictionary word set in the dictionary, into a dictionary word in another language based on the corresponding relationship extracted by the inter-word corresponding relationship extraction unit.

6. The document classification apparatus according to claim 2, further comprising:
a dictionary storage unit configured to store a dictionary used to define a word use method of the case-based document classification unit;
a dictionary setting unit configured to set one or some of an important word on which importance is placed in classification of the document, an unnecessary word to be neglected in classification of the document, and synonyms regarded as identical in classification of the document as a dictionary word in the dictionary; and
a dictionary conversion unit configured to convert a dictionary word described in a certain language and set in the dictionary into a dictionary word in another language based on the corresponding relationship extracted by the inter-word corresponding relationship extraction unit.

7. The document classification apparatus according to claim 3, further comprising:
a dictionary storage unit configured to store a dictionary used to define a word use method of the category feature word extraction unit;
a dictionary setting unit configured to set one or some of an important word on which importance is placed in classification of the document, an unnecessary word to be neglected in classification of the document, and synonyms regarded as identical in classification of the document as a dictionary word in the dictionary; and
a dictionary conversion unit configured to convert a dictionary word described in a certain language and set in the dictionary into a dictionary word in another language based on the corresponding relationship extracted by the inter-word corresponding relationship extraction unit.

8. A document classification method applied to a document classification apparatus including a document storage unit configured to store a plurality of documents in different languages, an inter-document corresponding relationship storage unit configured to store a corresponding relationship between the documents in the different languages which are stored in the document storage unit, and a category storage unit configured to store a category to classify the plurality of documents stored in the document storage unit, comprising:
extracting words from the documents stored in the document storage unit;
extracting the corresponding relationship between the words using the corresponding relationship stored in the inter-document corresponding relationship storage unit and based on a frequency with which the extracted words co-occurrently appear between the documents having the corresponding relationship;
generating the category for each language by clustering, based on a similarity of the frequency with which the extracted words appear between the documents in the same language, which are stored in the document storage unit, the plurality of documents described in the language; and
extracting the corresponding relationship between the categories into which the documents in the different languages are classified by assuming that the more inter-word corresponding relationships there are between a word that frequently appears in a document classified into a certain category and a word that frequently appears in a document classified into another category, the higher the similarity between the categories is, based on the frequency of the word that appears in the document classified into the generated category for each language and the extracted corresponding relationship.
